(19) United States
(12) Patent Application Publication
(10) Pub. No.: US 2025/0319640 A1
(43) Pub. Date: Oct. 16, 2025

(54) ACTIVE AND/OR INTELLIGENT PACKAGING MATERIALS CONTAINING RADICAL SCAVENGING LIGANDS

(71) Applicant: CORNELL UNIVERSITY, Ithaca, NY (US)

(72) Inventors: Julie M. GODDARD, Ithaca, NY (US); Halle N. REDFEARN, Laguna Beach, CA (US)

(21) Appl. No.: 18/861,012

(22) PCT Filed: May 1, 2023
(86) PCT No.: PCT/US2023/066445

§ 371 Date: Oct. 28, 2024

Related U.S. Application Data
(60) Provisional application No. 63/336,589, filed on Apr. 29, 2022.

(51) Int. Cl. B29C 48/00; B29C 48/08; C08F 255/02; C08J 5/18

(52) U.S. Cl. CPC B29C 48/022; B29C 48/08; C08F 255/02; C08J 5/18

(57) ABSTRACT

Disclosed herein are methods of making active and/or intelligent materials, the materials obtained from such methods, methods of forming packaging or containers from those materials, the packaging or containers that are formed using those active and/or intelligent packaging materials, and methods of packaging perishable food in a food package prepared from such active and/or intelligent packaging materials.

This application claims priority benefit of U.S. Provisional Patent Application Ser. No. 63/336,589, filed Apr. 29, 2022, which is hereby incorporated by reference in its entirety.

This invention was made with government support under Grant Nos. 2019-68015-29230 and 2019-38420-28975 awarded by the U.S. Department of Agriculture. The government has certain rights in the invention.

### FIELD

The invention relates to active and/or intelligent packaging materials, methods of making the same, packaging or containers that include such materials, and methods of using the same.

### BACKGROUND

The USDA estimates that 30-40% of the total food supply in the United States goes to waste each year, with approximately 31% of that waste occurring at the consumer and retail levels (USFDA, “Food Loss and Waste” (2021) (available from: https://www.fda.gov/food/consumers/food-loss-and-waste)). Microbial growth and oxidation are the two prominent driving forces of food spoilage due to degradative mechanisms that alter the sensory characteristics of products and lead to consumer rejection (Petruzzi et al., Chapter 1-“Microbial Spoilage of Foods: Fundamentals,” In: The Microbiological Quality of Food, Bevilacqua et al., eds, Woodhead Publishing (2017), pp. 1-21). While unit operations such as ultra-high temperature processing (UHT), and product formulation techniques such as acidification are used to inhibit microbial growth (USFDA, “Food Irradiation: What You Need to Know” (2018) (available from: https://www.fda.gov/food/buy-store-serve-safe-food/food-irradiation-what-you-need-know); Rajmohan et al., “Enzymes from Isolates of Pseudomonas Fluorescens Involved in Food Spoilage,” Journal of Applied Microbiology 93 (2): 205-13 (2002); Pérez-Diaz et al., “Microbial Growth and the Effects of Mild Acidification and Preservatives in Refrigerated Sweet Potato Puree,” J Food Prot. 71 (3): 639-42 (2008)), survival of heat-resistant microorganisms (Dogan et al., “Genetic Diversity and Spoilage Potentials Among Pseudomonas spp. Isolated from Fluid Milk Products and Dairy Processing Plants,” Appl Environ Microbiol. 69 (1): 130-8 (2003); Huck et al., “Tracking Heat-Resistant, Cold-Thriving Fluid Milk Spoilage Bacteria from Farm to Packaged Product,” J Dairy Sci. 91 (3): 1218-28 (2008); Snyder et al., “The Incidence and Impact of Microbial Spoilage in the Production of Fruit and Vegetable Juices as Reported by Juice Manufacturers,” Food Control. 85:144-50 (2018)) as well as post-process contamination (Eneroth et al., “Critical Contamination Sites in the Production Line of Pasteurised Milk, with Reference to the Psychrotrophic Spoilage Flora,” International Dairy Journal (9): 829-34 (1998); Poghossian et al., “Rapid Methods and Sensors for Milk Quality Monitoring and Spoilage Detection,” Biosens Bioelectron 140:111272 (2019)) has prompted the use of antimicrobial preservatives to prevent microbial spoilage. Similarly, methods to mitigate oxidative degradation such as vacuum sealing, gas flushing, and high-barrier packaging materials are imperfect (Cichello S A., “Oxygen Absorbers in Food Preservation: A Review,” Journal of Food Science and Technology 52 (4): 1889-95 (2015); Gómez-Estaca et al., “Advances in Antioxidant Active Food Packaging,” Trends in Food Science & Technology 35 (1): 42-51 (2014)), necessitating the use of antioxidant preservatives in products susceptible to oxidative degradation. Traditional preservatives rely on the direct addition of active compounds to the food matrix (Carocho et al., “Adding Molecules to Food, Pros and Cons: A Review on Synthetic and Natural Food Additives,” Comprehensive Reviews in Food Science and Food Safety 13 (4): 377-99 (2014)), but consumer trends toward “clean” labels and increasing demand for longer shelf life have prompted research in new preservation technologies (Yildirim et al., “Active Packaging Applications for Food,” Comprehensive Reviews in Food Science and Food Safety 17 (1): 165-99 (2018)). Active packaging materials such as those incorporating polyphenol antimicrobial and antioxidant agents (Liu et al., “Preparation of Gelatin Films Incorporated with Tea Polyphenol Nanoparticles for Enhancing Controlled-Release Antioxidant Properties,” J Agric Food Chem.63 (15): 3987-95 (2015); Silva et al., “Encapsulation of Coriander Essential Oil in Cyclodextrin Nanosponges: A New Strategy to Promote its Use in Controlled-Release Active Packaging,” Innovative Food Science & Emerging Technologies 56:102177 (2019); Chollakup et al., “Antioxidant and Antibacterial Activities of Cassava Starch and Whey Protein Blend Films Containing Rambutan Peel Extract and Cinnamon Oil for Active Packaging,” LWT 130:109573 (2020) have the potential to prolong preservative functionality through controlled release (Kuai et al., “Controlled Release of Antioxidants from Active Food Packaging: A Review,” Food Hydrocolloids 120:106992 (2021)) of active compounds and ease consumer label concerns through use of natural preservatives (Contini et al., “Development of Active Packaging Containing Natural Antioxidants,” Procedia Food Science 1:224-8 (2011)). However, migratory active packaging has several drawbacks, including the necessary approval of active agents as direct additives (Bastarrachea et al., “Active Packaging Coatings,” (Coatings 5 (4) (2015); Vasile et al., “Progresses in Food Packaging, Food Quality, and Safety-Controlled-Release Antioxidant and/or Antimicrobial Packaging,” Molecules 26 (5): 1263 (2021)), adverse impact to material mechanical properties (Chen et al., “Development of New Multilayer Active Packaging Films with Controlled Release Property Based on Polypropylene/Poly (Vinyl Alcohol)/Polypropylene Incorporated with Tea Polyphenols,” J Food Sci. 84 (7): 1836-43 (2019); Zaitoon et al., “Triggered and Controlled Release of Active Gaseous/Volatile Compounds for Active Packaging Applications of Agri-Food Products: A Review,” Comprehensive Reviews in Food Science and Food Safety 21 (1): 541-79 (2022)), and often negative effects on product quality (Bastarrachea et al., “Active Packaging Coatings,” Coatings 5 (4): 771-791 (2015)). Thus, there has been a new wave of active packaging technologies in which the active ligand is covalently bound to the packaging matrix to render it immobilized/nonmigratory. Prior research has demonstrated that covalent modification of polypropylene (PP) with iminodiacetic acid (Lin et al., “Synthesis of Iminodiacetate Functionalized Polypropylene Films and Their Efficacy as Antioxidant Active-Packaging Materials,” J Agric Food Chem.64 (22): 4606-17 (2016)), acrylic acid (Tian et al., “Control of Lipid Oxidation by Nonmigratory Active Packaging Films Prepared by Photoinitiated Graft Polymerization,” J Agric Food Chem.60 (31): 7710-8 (2012)), tannic acid (Hazer et al., “Synthesis of a Novel Tannic Acid-Functionalized Polypropylene as Antioxidant Active-Packaging Materials,” Food Chem. 344:128644 (2021)), and polylysine (Doshna et al., “Antimicrobial Active Packaging Prepared by Reactive Extrusion of E-Poly l-lysine with Polypropylene,” AC'S Food Science & Technology (2021)) can extend shelf-life of food without the active agent leaching into the product. Compared to migratory active packaging and direct additives, nonmigratory active packaging can enhance the mechanical and optical properties of the packaging, prolong the lifespan of the active packaging functionality, and limit the effects of preservatives on the quality-flavor, texture, color—of the food (Goddard et al., “Covalent Attachment of Lactase to Low-Density Polyethylene Films,” J Food Sci. 72 (1): E036-E41 (2007); Arrua et al., “Immobilization of Caffeic Acid on a Polypropylene Film: Synthesis and Antioxidant Properties,” J Agric Food Chem. 58 (16): 9228-34 (2010)).

While active packaging technology and research has progressed at a rapid pace, commercial adoption has been limited by manufacturing process scale-up and regulatory requirements to ensure safety (Werner et al., “Hurdles to Commercial Translation of Next Generation Active Food Packaging Technologies,” Current Opinion in Food Science 16:40-8 (2017)). Reactive extrusion provides an alternative to traditional thermoplastic polymer processing methods (solution casting, compression molding, etc.) (Werner et al., “Hurdles to Commercial Translation of Next Generation Active Food Packaging Technologies,” Current Opinion in Food Science 16:40-8 (2017)) with the potential to reduce time, labor, cost, and complexity of manufacturing (Moad G., “The Synthesis of Polyolefin Graft Copolymers by Reactive Extrusion,” Prog Polym Sci. 24 (1): 81-142 (1999)). Previous work in the development of functional polymers has demonstrated the promise of reactive extrusion as a solvent-free, efficient, continuous, and single-step process (Moad G., “The Synthesis of Polyolefin Graft Copolymers by Reactive Extrusion,” Prog Polym Sci. 24 (1): 81-142 (1999)) for the covalent attachment of active compounds to thermoplastic polymers. For instance, N-halamine was radically grafted to PP for biocidal medical devices (Badrossamay et al., “Durable and Rechargeable Biocidal Polypropylene Polymers and Fibers Prepared by Using Reactive Extrusion,” Journal of Biomedical Materials Research Part B: Applied Biomaterials 89B (1): 93-101 (2009)), polylactic acid (PLA) was covalently modified with polyethylene glycol to improve mechanical properties (Hassouna et al., “New Approach on the Development of Plasticized Polylactide (PLA): Grafting of Poly (Ethylene Glycol) (PEG) via Reactive Extrusion,” Eur Polym J. 47 (11): 2134-44 (2011)), and poly (vinyl alcohol-co-ethylene) was functionalized with 2,4-diamino-6-diallylamino-1,3,5-triazine (NDAM) for antimicrobial medical and other hygienic products (Wang et al., “Radical Graft Polymerization of an Allyl Monomer onto Hydrophilic Polymers and Their Antibacterial Nanofibrous Membranes,” ACS Applied Materials & Interfaces 3 (8): 2838-44 (2011)). Reactive extrusion has also been used for the synthesis of nonmigratory active packaging. These include: (i) PLA grafted with nitrilotriacetic acid, which showed antioxidant activity (Herskovitz et al., “Antioxidant Functionalization of Biomaterials via Reactive Extrusion,” J Appl Polym Sci. 138 (25): 50591 (2021); Kay et al., “Interfacial Behavior of a Polylactic Acid Active Packaging Film Dictates its Performance in Complex Food Matrices,” Food Packaging and Shelf Life 32:100832 (2022)); and (ii) polylysine radically grafted to PP by reactive extrusion (Doshna et al., “Antimicrobial Active Packaging Prepared by Reactive Extrusion of &-Poly l-lysine with Polypropylene,” AC'S Food Science & Technology, 2 (3): 391-399 (2022)). Without the need for downstream processing, large volumes of solvent, or specialized equipment necessary for wet chemical or bench scale grafting methods, reactive extrusion provides an economic and potentially greener method to produce active materials.

Curcumin is an antioxidant and antimicrobial natural polyphenol responsible for the orange-yellow color and therapeutic value of Curcumin longa (turmeric) (Roy et al., “Curcumin and its Uses in Active and Smart Food Packaging Applications-A Comprehensive Review,” Food Chem. 375:131885 (2022)). As a biologically active GRAS (generally recognized as safe) compound, curcumin has a long history of use in medicine, food coloring and flavoring, and preservation (Sharifi-Rad et al., “Turmeric and its Major Compound Curcumin on Health: Bioactive Effects and Safety Profiles for Food, Pharmaceutical, Biotechnological and Medicinal Applications,” Frontiers in Pharmacology 11:01021 (2020)). The antimicrobial properties of curcumin are derived from inhibitory effect on bacterial cell proliferation (Zorofchian Moghadamtousi et al., “A Review on Antibacterial, Antiviral, and Antifungal Activity of Curcumin,” BioMed Research International 2014:186864 (2014); Teow et al., “Antibacterial Action of Curcumin Against Staphylococcus Aureus: A Brief Review,” Journal of Tropical Medicine 2016:2853045 (2016)) and disruption of membrane proteins in fungi (Lee et al., “An Antifungal Mechanism of Curcumin Lies in Membrane-Targeted Action within Candida Albicans,” IUBMB Life 66 (11): 780-5 (2014)). The antioxidant capacity of curcumin is attributed to its radical scavenging capacity by both hydrogen and electron donation (Barclay et al., “On the Antioxidant Mechanism of Curcumin: Classical Methods Are Needed to Determine Antioxidant Mechanism and Activity,” Org Lett. 2 (18): 2841-3 (2000); Ak et al., “Antioxidant and Radical Scavenging Properties of Curcumin,” Chem Biol Interact. 174 (1): 27-37 (2008); Jovanovic et al., “H-Atom Transfer Is A Preferred Antioxidant Mechanism of Curcumin,” Journal of the American Chemical Society 121 (41): 9677-81 (1999)) and metal chelating capacity by formation of complexes with the diketone (Refat, “Synthesis and Characterization of Ligational Behavior of Curcumin Drug Towards Some Transition Metal Ions: Chelation Effect on their Thermal Stability and Biological Activity,” Spectrochimica Acta Part A: Molecular and Biomolecular Spectroscopy 105:326-37 (2013)). Curcumin also has the ability to change color in alkaline conditions, such as those produced by meat and seafood during spoilage (Roy et al., “Curcumin and its Uses in Active and Smart Food Packaging Applications-A Comprehensive Review,” Food Chem. 375:131885 (2022)). Thus, curcumin is an ideal candidate for active and intelligent packaging applications, in which it has the potential to integrate antimicrobial and antioxidant to mitigate product spoilage, and color-indicating features to visually signify product spoilage. Accordingly, there has been significant work in the development of active packaging materials blended with curcumin with preserved functional performance, including low-density polyethylene (LDPE) (Zia et al., “Low-Density Polyethylene/Curcumin Melt Extruded Composites with Enhanced Water Vapor Barrier and Antioxidant Properties for Active Food Packaging,” Polymer 175:137-45 (2019); Zhai et al., “Extruded Low Density Polyethylene-Curcumin Film: A Hydrophobic Ammonia Sensor for Intelligent Food Packaging,” Food Packaging and Shelf Life 26:100595 (2020)), poly (lactic acid) (PLA) (Roy et al., “Preparation of Bioactive Functional Poly (Lactic Acid)/Curcumin Composite Film for Food Packaging Application,” Int J Biol Macromol 162:1780-9 (2020); Nguyen et al., “Characteristics of Curcumin-Loaded Poly (Lactic Acid) Nanofibers for Wound Healing,” Journal of Materials Science 48 (20): 7125-33 (2013)), and polybutylene adipate terephthalate (PBAT) (Roy et al., “Curcumin Incorporated Poly (Butylene Adipate-co-Terephthalate) Film with Improved Water Vapor Barrier and Antioxidant Properties,” Materials 13 (19) (2020)). Previous research has also demonstrated the intelligent properties of materials blended with curcumin to indicate spoilage of beef and silver carp (Zhai et al., “Extruded Low Density Polyethylene-Curcumin Film: A Hydrophobic Ammonia Sensor for Intelligent Food Packaging,” Food Packaging and Shelf Life 26:100595 (2020)), shrimp (Salarbashi et al., “pH-Sensitive Soluble Soybean Polysaccharide/SiO2 Incorporated with Curcumin for Intelligent Packaging Applications,” Food Science & Nutrition 9 (4): 2169-79 (2021); Wu et al., “Enhanced Functional Properties of Biopolymer Film Incorporated with Curcurmin-Loaded Mesoporous Silica Nanoparticles for Food Packaging,” Food Chem. 288:139-45 (2019); Liu et al., “Films Based on K-Carrageenan Incorporated with Curcumin for Freshness Monitoring,” Food Hydrocolloids 83:134-42 (2018); Ezati et al., “pH-Responsive Pectin-Based Multifunctional Films Incorporated with Curcumin and Sulfur Nanoparticles,” Carbohydr Polym 230:115638 (2020)), and chicken breast (Yildiz et al., “Monitoring Freshness of Chicken Breast by Using Natural Halochromic Curcumin Loaded Chitosan/PEO Nanofibers as an Intelligent Package,” Int J Biol Macromol. 170:437-46 (2021)). While these technologies demonstrate the retained functionality of curcumin embedded in hydrophobic polymer matrices, there has been no report of covalent immobilization of curcumin to develop nonmigratory packaging capable of both intelligent and preservative action.

The described invention is directed to overcoming these and other deficiencies in the art.

### SUMMARY

A first aspect of the present disclosure relates to a method of making an active and/or intelligent material. The method includes the steps of providing a polymeric material comprising a tertiary carbon or hydroxyl group; reacting the polymeric material with a radical scavenging ligand and a radical initiator in an extruder under distinct first and second reaction conditions to cause covalent binding of the radical scavenging ligand to the polymeric material by direct bond formation; and extruding the active and/or intelligent material.

In certain embodiments, the method can be used to make an active and/or intelligent packaging material, particularly a food-grade packaging material.

A second aspect of the present disclosure relates to a method of forming a food packaging material. The includes the steps of melting the active and/or intelligent packaging material prepared according to the first aspect of disclosure; and forming the melted active and/or intelligent packaging material into a shaped, food packaging material.

A third aspect of the present disclosure relates to an active and/or intelligent packaging material prepared according to the method of the first aspect of disclosure.

A fourth aspect of the present disclosure relates to a food packaging material prepared according to the method of the second aspect of disclosure.

A fifth aspect of the present disclosure relates to an active and/or intelligent packaging material that includes a polymeric material having covalently attached thereto a radical scavenging ligand.

A fifth aspect of the present disclosure relates to a method of packaging perishable food. The method includes the step of sealing a perishable food item in a package comprising an active and/or intelligent packaging material according to the third or fifth aspect of the disclosure, whereby the food item contacts a surface of the active and/or intelligent packaging material and the radical scavenging ligand thereon.

The environmental and economic burden of food waste demands new preservation technologies to reduce the degradative actions of spoilage such as moisture, oxygen, and microorganisms. Direct food additives can help maintain product quality; however, the limited lifespan of these additives combined with consumer desire for “clean label” products has motivated research into new food manufacturing technologies like active and intelligent packaging that can prevent and detect food spoilage. In this work, curcumin was grafted to polypropylene (PP-g-Cur) via reactive extrusion to produce nonmigratory active and intelligent packaging through a solvent-free, efficient, and continuous method. Immobilization of curcumin was confirmed by a standard migration assay exhibiting a maximum of 0.011 mg/cm² migration, significantly below the EU migratory limit for food contact materials (0.1 mg/cm²). Compared to native PP films, PP-g-Cur films blocked 93% of UV light while retaining 64% transparency in the visible region, allowing for desirable product visibility while inhibiting UV degradation of packaged goods. While the ability of PP-g-Cur to inhibit growth of E. coli and L. monocytogenes was insignificant compared to control PP; free curcumin exhibited poor bacterial inhibition as well, indicating that without hydrophilic modification, native curcumin has limited antimicrobial efficacy. PP-g-Cur films displayed significant radical scavenging in both organic (11.71±3.02 Trolox_{Eq} (nmol/cm2)) and aqueous (3.18±1.04 Trolox_{Eq} (nmol/cm2)) matrices, exhibiting potential for antioxidant behavior in both lipophilic and hydrophilic applications. Finally, when PP-g-Cur films were exposed to ammonia, an indicator of microbial growth, the color visually and quantitatively changed from yellow to red, demonstrating potential to indicate spoilage. These findings demonstrate the potential of a scalable technology to produce active and intelligent packaging to limit food waste and advance the capabilities of functional materials in a variety of applications.

The aim of the accompanying Examples was to functionalize a thermoplastic polymer common in food packaging, polypropylene (PP), with curcumin through an industrially translatable method to produce active and intelligent packaging. The polymer modification was accomplished through radical grafting with a peroxide initiator via reactive extrusion. Previous research demonstrated radical grafting of gallic acid onto chitosan using wet chemical methods, which indicated the radical initially forms on the phenolic oxygen of the polyphenol by hydrogen abstraction (Curcio et al., “Covalent Insertion of Antioxidant Molecules on Chitosan by a Free Radical Grafting Procedure,” J Agric Food Chem. 57 (13): 5933-8 (2009); Cirillo et al., “Antioxidant Multi-Walled Carbon Nanotubes by Free Radical Grafting of Gallic Acid: New Materials For Biomedical Applications,” J Pharm Pharmacol. 63 (2): 179-88 (2011); Spizzirri et al., “Innovative Antioxidant Thermo-Responsive Hydrogels by Radical Grafting of Catechin on Inulin Chain,” Carbohydr Polym. 84 (1): 517-23. (2011); Cho et al., “Preparation, Characterization, and Antioxidant Properties of Gallic Acid-Grafted-Chitosans,” Carbohydr Polym. 83 (4): 1617-22 (2011), each of which is hereby incorporated by reference in its entirety). However, a dimerization process results in radical grafting of the aromatic ring of the polyphenol at the ortho or para position relative to the hydroxyl (Curcio et al., “Covalent Insertion of Antioxidant Molecules on Chitosan by a Free Radical Grafting Procedure,” J Agric Food Chem. 57 (13): 5933-8 (2009); Uyama et al., “Peroxidase-Catalyzed Oxidative Polymerization of Bisphenols,” Biomacromolecules 3 (1): 187-93 (2002); Kobayashi et al., “Oxidative Polymerization of Phenols Revisited,” Prog Polym Sci. 28 (6): 1015-48 (2003)). It was hypothesized that, since the functional groups responsible for curcumin's antioxidant and antimicrobial capacity are not employed in the grafting reaction, the active functionality of curcumin will be preserved. These previous works demonstrated covalent immobilization of polyphenols via radical grafting with retained antioxidant activity; however, they utilize lengthy (over 24 hours) and multistep processes limiting pragmatic commercial translation. Radical grafting of curcumin onto polypropylene via reactive extrusion has great potential to produce nonmigratory active packaging through a scalable, environmentally friendlier, and economic method. It is believed that this is the first time reactive extrusion has been used to produce nonmigratory multifunctional packaging, in particular via radical grafting, thus advancing the capabilities and commercial viability of functional materials both in food applications and beyond.

### BRIEF DESCRIPTION OF THE DRAWINGS

FIGS. 1A-B show exemplary processes for preparing an active and/or intelligent packaging materials using reactive extrusion of a polymer, a ligand, and an initiator. The active and/or intelligent packaging material can be used directly or converted to a pellet formation, which is the industrial product that can be converted by various bolding or film-forming processes to produce finished products, e.g., single-layer films, multi-layer films, or containers that are suitable for packaging foods.

FIG. 2 illustrates a reaction scheme for the radical grafting of curcumin to polypropylene (PP) during reactive extrusion to form polypropylene-graft-curcumin (PP-g-Cur).

FIG. 3 illustrates a reaction scheme for the radical grafting of curcumin to starch, an exemplary hydroxyl-containing polymer, during reactive extrusion to form starch-graft-curcumin.

FIG. 4 illustrates a reaction scheme for the radical grafting of curcumin to polylactic acid (PLA) during reactive extrusion to form polylactic acid-graft-curcumin (PLA-g-Cur).

FIGS. 5A-B show ATR-FTIR spectra of control and curcumin-treated films, which confirm the presence of curcumin in sample films. Characteristic PP alkyl bands are represented along with highlighted bands characteristic of curcumin's aromatic ring (FIG. 5A). PP-g-MA carboxylic acid and anhydride carbonyl bands are shown, and curcumin ethylene bands are highlighted (FIG. 5B).

FIG. 6 is a migration study of treated and control films at 40° C. for 10 days in water, 3% acetic acid, 10% EtOH, 50% EtOH, and 95% EtOH. All films had curcumin migration significantly below the EU migratory limit for food contact materials (0.1 mg/cm²). Values are the average and 95% confidence intervals of four replicates for each of two independently extruded batches. Statistically significant differences between the mean of each sample compared to the mean of PP for each simulant are signified by color-coded asterisks (Dunnett's HSD, p≤0.05).

FIG. 7 shows UV-vis spectrophotometry spectra (280-800 nm) of treated and control films to demonstrate UV blocking and visible light transmission of treated films. UV-B (280-315 nm), UV-A (315-400 nm), and visible (400-700 nm) light spectra are indicated by blue, orange, and green highlighting (in color figure), respectively. Absorbance measurements were taken every 2 nm for two replicates from each of two independently extruded. Points shown are the average of all replicates for each sample.

FIG. 8 shows ABTS and DPPH radical scavenging assay of control and treated films to demonstrate antioxidant performance of PP-g-Cur films in different matrices. Values are the average and 95% confidence intervals of eight replicates (ΔBTS) and six replicates (DPPH) for each of two independently extruded batches of each treatment. Statistically significant differences between sample means for each assay are signified by color-coded letters (Tukey's HSD, p≤0.05).

FIG. 9 shows a bacterial growth inhibition assay to display the antibacterial performance of treated films and free curcumin. Results represent the log difference in plate counts between the control and treated samples. Values for treated films are the average and standard deviation of three replicates for each of two independently extruded batches of each treatment. Values for free curcumin are the average and standard deviation of three replicates. Statistically significant differences between sample means for each bacterial strain are signified by color-coded letters (Tukey's HSD, p≤0.05).

FIGS. 10A-B summarize a colorimeter analysis of PP-g-Cur films. FIG. 10A shows CIELab color change values of PP-g-Cur films to demonstrate quantifiable intelligent film properties in the presence of ammonia gas (original figure in color). FIG. 10B shows photographs of treated films before and after ammonia exposure to demonstrate visual color change for food applications to indicate spoilage to consumers and manufacturers (original figure in color). Values are the average and standard deviation of three replicates for each of two independently extruded batches. Statistically significant differences between sample means are indicated by color-coded letters (Tukey's HSD, p≤0.05).

FIG. 11 shows full FTIR spectra of treated and control films. FTIR analysis was performed on two independent spots on two independent coupons for two independently prepared batches of each sample. A random number generator was used to pick one of the eight spectra as a representation for each sample.

FIG. 12 shows TGA thermogram of curcumin powder, control, and treated films. Samples were heated at a rate of 10° C./min under nitrogen. Spectra are representative of a single replicate from each sample.

FIGS. 13A-G show DSC thermograms of curcumin powder, control, and treated films. Samples were heated and cooled at a rate of 10° C./min under nitrogen. Spectra are representative of a single replicate from each sample.

FIG. 14 shows UV-vis spectra of three replicate curcumin solutions from 300-700 nm to determine the wavelength with maximum absorption. Peak absorption occurred at 428 nm, which was the wavelength used to quantify curcumin migration from films.

FIGS. 15A-E show standard curves of curcumin in various food simulants to quantify curcumin migration from films. Simulants include H₂O (FIG. 15A), 3% acetic acid (FIG. 15B), 10% ethanol (FIG. 15C), 50% ethanol (FIG. 15D), and 95% ethanol (FIG. 15E). Standard curves used curcumin stock solutions of 0.1 mg/mL in 100% ethanol prior to dilution in each simulant to ensure complete solubilization. Points represent the average and standard deviation of three replicate standard curves for each simulant.

FIGS. 16A-D show time trial experiments for aqueous ABTS (FIG. 16A), organic ABTS (FIG. 16B), and organic DPPH (FIG. 16C) radical scavenging assays to determine the optimal incubation time for antioxidant activity. Absorbance of the control blank solution (containing no film) was plotted against time to track radical stability (FIG. 16D). A pH 4.5 buffered radical solution was plotted as well to show improved radical stability in acidic compared to neutral or organic matrices. Incubation times for each assay were chosen based on the highest radical scavenging capacity while the blank solution maintained greater than 50% its initial absorbance (indicated by dashed line). Assays were performed on triplicate samples from a single representative batch of films and radical solution, and values represent the average and standard deviation.

FIG. 17 shows accelerated ascorbic acid degradation assay to show lack of metal chelating ability of sample and treated films. The assay was performed at pH 4 to represent typical food systems, which is significantly below the pKₐ values of curcumin. Values represent the average and standard deviation from four replicates of each sample for each of two independently extruded batches.

FIG. 18 shows application of color changing PP-g-Cur films to indicate spoilage of shrimp. During spoilage, microorganisms release of volatile basic nitrogen compounds, which react with curcumin and change the color of PP-g-Cur films from yellow to red. Total viable count (TVC) of the shrimp increases with the total color change (ΔE*) of the films during shrimp storage at 4° C., demonstrating the ability of PP-g-Cur films to indicate microbial spoilage in real food applications. Values are the average and standard deviation of three replicates for each time point.

FIG. 19 shows UV-vis spectrophotometry of PLA-g-Cur films containing 1% and 2% w/w curcumin compared to control PLA. UV-B (280-315 nm), UV-A (315-400 nm), and visible (400-700 nm) light spectra are indicated by yellow, red, and blue highlighting (in color figure), respectively. Treated films demonstrated nearly complete blocking of all UV wavelengths while allowing visible light transmission comparable to control PLA, particularly at the wavelength indicative of material transparency (600 nm). UV-vis properties exhibit the ability of PLA-g-Cur films to maintain desirable product visibility while inhibiting UV degradation of packaged goods. Absorbance measurements were taken every 2 nm for three replicates of each sample. Points shown are the average of all replicates for each sample.

FIG. 20 shows FTIR spectra of PLA-g-Cur films containing 1% and 2% w/w curcumin compared to control PLA. Sample films demonstrate absorbance bands at 1629 cm⁻¹, 1575-1540 cm⁻¹, and 1515 cm⁻¹, characteristic of curcumin carbonyl C═O stretching (yellow in color figure), aromatic C—C═C stretching (red in color figure), and ethylene C═C stretching (blue in color figure), respectively, indicating the presence of curcumin in PLA-g-Cur films post-ethanol wash.

FIGS. 21A-C illustrate exemplary active, food-grade packaging materials including a single-layer film (FIG. 21A), a multi-layer film (FIG. 21B), and a container (FIG. 21C) that includes a body and a mating lid (see U.S. Design Patent D681451, which is hereby incorporated by reference in its entirety).

### DETAILED DESCRIPTION

Disclosed herein are methods of making active and/or intelligent packaging materials, the materials obtained from such methods, methods of forming packaging or containers from those materials, the packaging or containers that are formed using those active and/or intelligent packaging materials, and methods of packaging perishable food in a food package prepared from such active and/or intelligent packaging materials.

As used herein, “active packaging material” refers to a packaging material that is functionalized with antioxidant and/or antimicrobial agents; “intelligent packaging material” refers to a packaging material that is capable of indicating spoilage; and “smart packaging materials” refers generally to both active packaging materials and intelligent packaging materials. Smart packaging materials may also be both active and intelligent.

One aspect relates to a method of making an active and/or intelligent packaging material. The method includes the steps of providing a polymeric material that includes a tertiary carbon or hydroxyl group; reacting the polymeric material with a radical scavenging ligand and a radical initiator in an extruder under distinct first and second reaction conditions to cause covalent binding of the radical scavenging ligand to the polymeric material by direct bond formation; and extruding the active and/or intelligent packaging material. Direct bond formation preferably occurs between the radical scavenging ligand and either the tertiary carbon or the oxygen of hydroxyl group.

To ensure relatively uniform distribution of the radical scavenging ligand throughout the active and/or intelligent packaging material, it is desirable to adequately mix the polymeric material with the radical scavenging ligand and the radical initiator to form a mixture before the reacting step.

In certain embodiments, the mixture comprises the polymeric material, the radical scavenging ligand, and the radical initiator. The mixture may optionally include a second polymeric material or monomers or low molecular weight oligomers of the (initial) polymeric material.

In another embodiment, the mixture consists essentially of, or consists of, the polymeric material, the radical scavenging ligand, and the radical initiator.

Any suitable polymeric materials suitable for reactive extrusion can be used in the manufacture of the active and/or intelligent packaging material. Exemplary polymeric materials include, without limitation, polymeric material is selected from the group consisting of polylactic acid, polypropylene, polybutylene, polyhydroxy butyrate, starch, cellulose, alginate, ethylene vinyl alcohol, polyvinyl alcohol, and copolymers containing one or more thereof. Suitable polypropylenes include, without limitation, atactic as well as isotactic polypropylenes, and combinations thereof.

These polymeric materials can also be copolymerized with one or more polymeric material that lack a tertiary carbon or hydroxyl group such as polyethylene and other food-grade polymeric materials.

The molecular weight of a polymeric material, a measure of its molecular chain length, can significantly affect the physical properties of the polymer. As molecular weight increases, tensile and impact strengths increase sharply before leveling off, whereas melt viscosity increases slowly and then sharply. Typically, the practical molecular weight range for packaging polymers is between 50-200 KDa. See Yam, “Packaging Material Molecular Weight,” In: Encyclopedia of Polymer Science and Technology, John Wiley & Sons, Inc., doi: 10.1002/0471440264.pst569 (2010).

The polymeric materials typically make up from about 85 to about 99.5 weight percent, preferably about 90 to about 98 weight percent or about 90 to about 95 weight percent, of the total weight of the material charged into the extruder.

Any number of suitable radical scavenging ligands that are resistant to heat (as used during reactive extrusion) and can contribute to reduced food spoilage or changing as an indicator of food spoilage while non-migratory, i.e., remaining covalently linked to the polymeric material, can be used in making the active and/or intelligent packaging materials.

Radical scavenging ligands that can be used include, without limitation, phenolic or polyphenolic ligands, and hydroxylamine ligands.

Exemplary phenolic or polyphenolic ligands include, without limitation, curcumin, curcumin derivatives such as cyclovalone and p-hydroxycinnamoyl-feruloylmethane, ferulic acid, quercetin, catechol, catechin, stillbenoids such as resveratrol, piceatannol, and 4,4′-Dihydroxy-3,3′-dimethoxy-stilbene, and any combination of two or more phenolic or polyphenolic ligands thereof. Depending on the particular polymeric material, the phenolic or polyphenolic ligands will form a direct bond with either a tertiary carbon or the oxygen of hydroxyl group on the polymeric material, specifically between a ring carbon of the phenolic or polyphenolic ligand and either the tertiary carbon or the hydroxyl oxygen of the polymeric material.

Exemplary hydroxylamine ligands include, without limitation, hydroxyurea (HU), didox, trimidox, and hydroxyguanidine. The hydroxylamine ligands will form a direct bond with a tertiary carbon on the polymeric material, specifically between the hydroxyl oxygen of the hydroxylamine ligand and the tertiary carbon of the polymeric material.

As indicated in the description below, it is desirable in certain embodiments that the radical scavenging ligand is used with a polymeric material that (i) has a lower melting point, and (ii) is capable of undergoing free radical substitution with the radical scavenging ligand. Preferably, the difference in the melting point of the polymeric material and the radical scavenging ligand is at least about 10° C., more preferably at least about 12° C., at least about 14° C., at least about 16° C., at least about 18° C., or at least about 20° C. By using a polymeric material that has a lower melting point than the radical scavenging ligand, it becomes possible to introduce a mixture containing the polymeric material, the radical scavenging ligand, and the radical initiator into the extruder and utilizing a first set of reaction conditions that promote radical formation on the polymeric material but minimal radical formation on the radical scavenging ligand (primarily due to the radical scavenging ligand remaining in a solid state).

By way of example, curcumin has a melting point of ˜183° C., whereas polypropylene has a melting point of ˜160° C. and polylactic acid has a melting temperature of ˜150-160° C. Thus, temperatures great than 160° C. and below 183° C., such as between about 162° C. and about 178° C., or between about 165° C. and about 175° C., are ideal for this combination of radical scavenging ligand and polymeric materials.

In an alternative embodiment, the radical scavenging ligand is used with a polymeric material that (i) has a higher melting point, and (ii) is capable of undergoing free radical substitution with the radical scavenging ligand. Preferably, the melting point of the polymeric material is not so high that it will significantly diminish or destroy the radical scavenging capabilities of the radical scavenging ligand.

The radical scavenging ligand typically makes up from about 0.1 to about 5 weight percent, preferably about 0.25 to about 5 weight percent (including about 0.5 to about 5 weight percent, about 0.5 to about 4 weight percent, about 0.75 to about 3 weight percent, or about 1 to about 3 weight percent) of the total weight of the material charged into the extruder.

The amount required will depend, in part, on the intended use of the packaging product (e.g., film or container or coating) formed from the active and/or intelligent packaging material. For example, some foods and beverages are more oxidatively stable, in which case less ligand may be required to maintain food freshness.

Any suitable radical initiators can be used in forming the active and/or intelligent packaging materials by causing direct linkage between the polymer material and the radical scavenging ligand(s) present in the mixture exposed to reactive extrusion. Exemplary radical initiators include, without limitation, peroxide initiators and benzoate-based initiators.

Exemplary peroxide initiators include ketone peroxides, hydroperoxides, diacylperoxides, dialkylperoxides, peroxyketals, alkyl peresters (peroxy esters), peroxycarbonates, and combinations thereof. Of these, diacylperoxides (e.g., dibenzoyl, dilauroyl, didecanoyl, bis (p-chlorobenzoyl), di(4-methylbenzoyl), and bis(2,4-dichlorobenzoyl) peroxides) and dialkylperoxides (e.g., di-t-butyl and dicumyl peroxides) are suitable. In the accompanying examples, dicumyl peroxide is shown to be quite effective. Preferred peroxide initiators include, without limitation, dicumyl peroxide, benzoyl peroxide, lauroyl peroxide, dodecanoyl peroxide, tert-butyl peroxybenzoate, tert-butyl perbenzoate, di (4-methylbenzoyl) peroxide, and a combination thereof. Other suitable peroxide initiators are described in Denisov et al., Handbook of Free Radical Initiators, Wiley (2005), which is hereby incorporated by reference in its entirety.

Exemplary benzoate-based initiators tert-butyl peroxybenzoate and tert-butyl perbenzoate, and combinations thereof.

The radical initiator(s) typically make up from about 0.1 to about 2 weight percent, preferably about 0.1 to about 1.5 weight percent, about 0.1 to about 1 weight percent, or about 0.1 to about 0.75 weight percent, of the total weight of the material charged into the extruder.

In addition to the foregoing, the mixture used to form the active and/or intelligent packaging material may optionally include one or more of light stabilizers, ultraviolet absorbers, plasticizers, compatibilizers, inorganic fillers, colorants, antistatic agents, lubricants, mold release agents, flame retardants, leveling agent, de-foaming agents, or the like within a range that does not inhibit advantageous effects of the invention.

Exemplary active and/or intelligent, food-grade packaging materials are identified in the examples using polylactic acid or polypropylene as the polymeric material, and curcumin as the radical scavenging ligand.

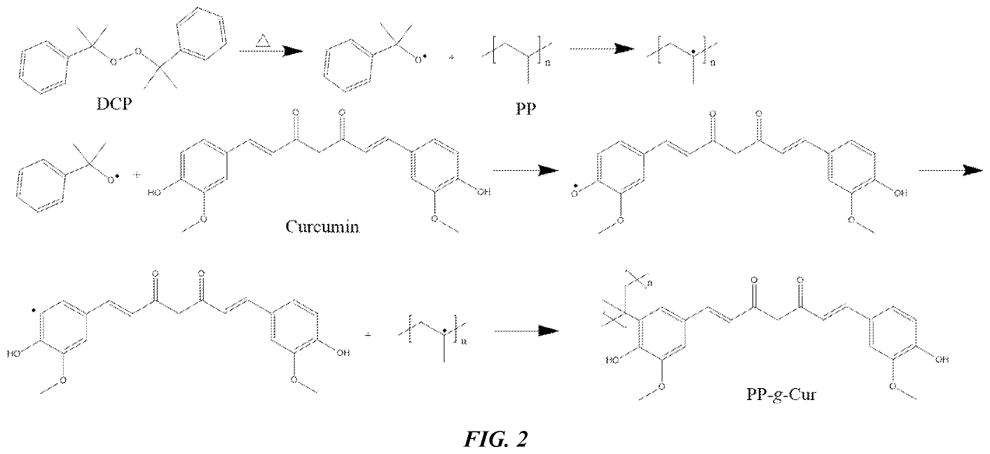

An exemplary synthesis scheme for the preparation of polypropylene grafted curcumin (PP-g-Cur) is illustrated in FIG. 2, which shows dicumyl peroxide as a radical initiator for generation of a radical in the polypropylene in one step and a curcumin radical, which radicals react to form the PP-g-Cur packaging material. The curcumin is directly bonded to the tertiary carbon in the polypropylene.

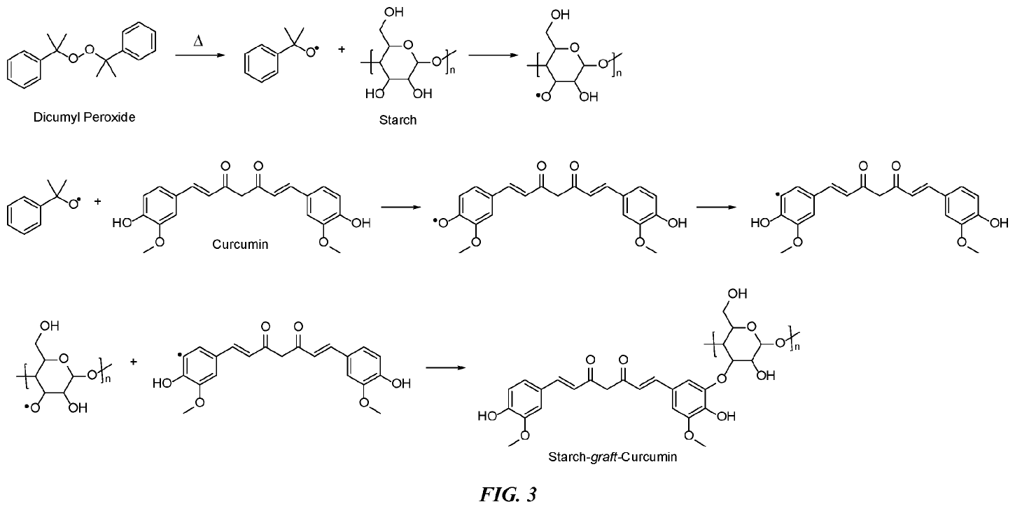

An exemplary synthesis scheme for the preparation of starch grafted curcumin (Starch-g-Cur) is illustrated in FIG. 3, which shows dicumyl peroxide as a radical initiator for generation of a radical in the starch in one step and a curcumin radical, which radicals react to form the Starch-g-Cur packaging material. The curcumin is directly bonded to a pendant oxygen (former hydroxyl group) in the starch.

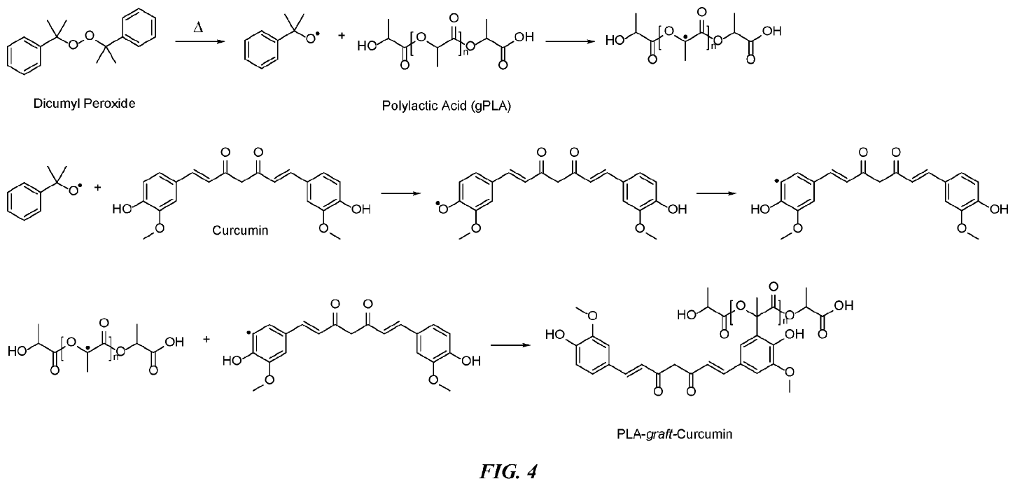

An exemplary synthesis scheme for the preparation of polylactic acid grafted curcumin (PLA-g-Cur) is illustrated in FIG. 4, which shows dicumyl peroxide as a radical initiator for generation of a radical in the polylactic acid in one step and a curcumin radical, which radicals react to form the PLA-g-Cur packaging material. The curcumin is directly bonded to the tertiary carbon in the polypropylene.

In each of these embodiments, the curcumin ligand is covalently bound to the polymer backbone throughout the polymeric material (i.e., on the surface of the resulting solid product retrieved from the extruder, or pelletizer, as well as internally thereof). As a consequence, when the polymeric material is later used to form an active and/or intelligent packaging material, the radical scavenging ligand is covalently bound to the polymer backbone on all surfaces thereof (i.e., both food contact surfaces and non-food contact surfaces when the packaging is used for food).

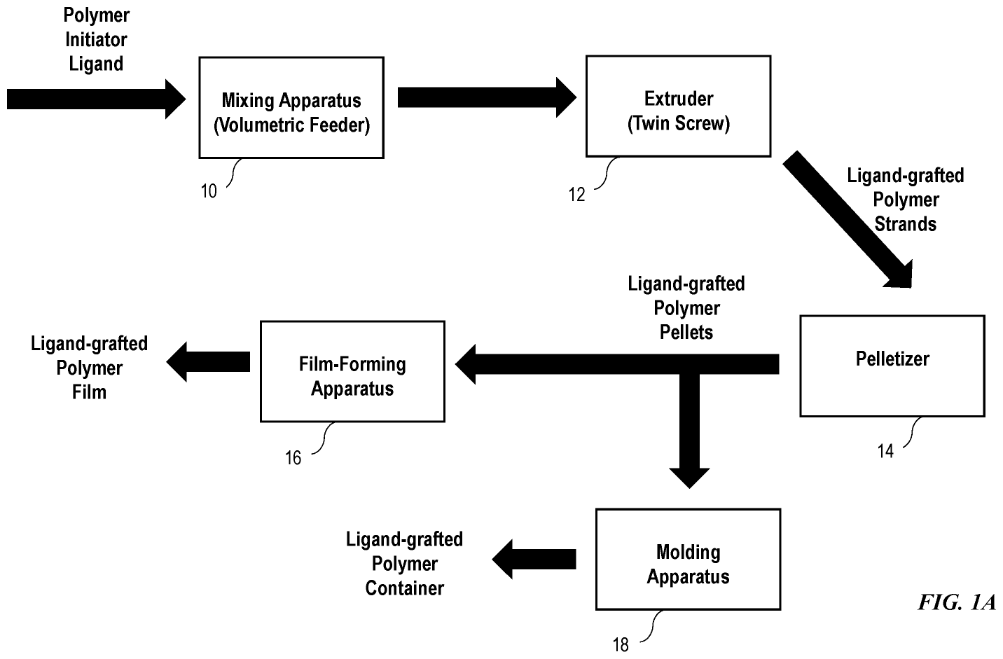

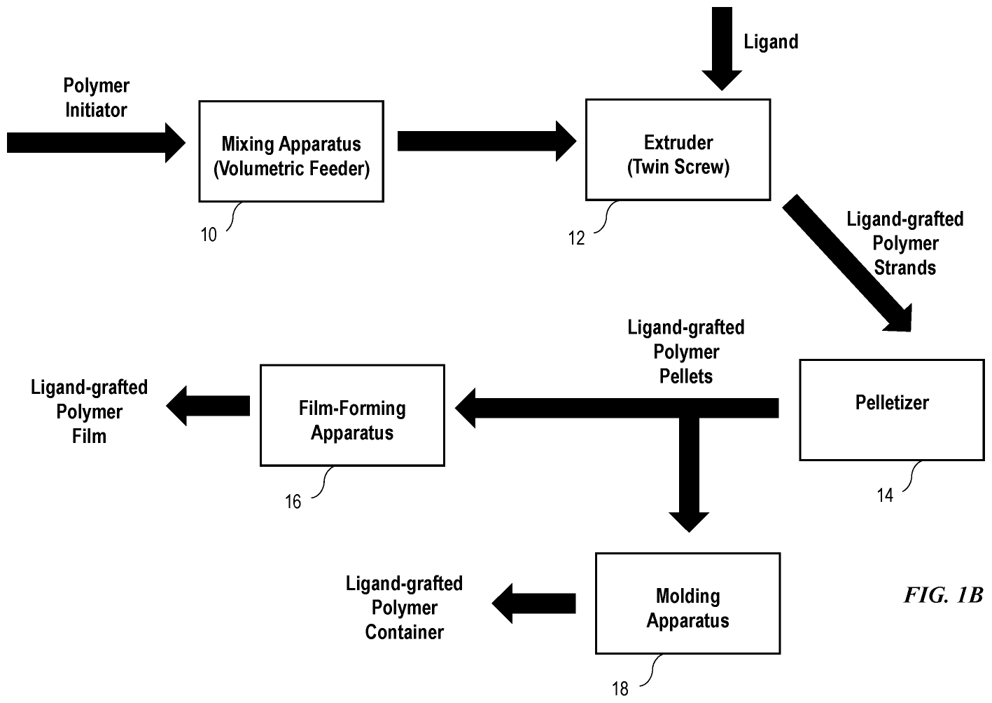

One exemplary method for making the active and/or intelligent packaging material is illustrated in FIG. 1A. In step 10, the polymeric material(s), radical scavenging ligand(s), and radical initiator are introduced into a suitable mixing device and mixed for a sufficient period of time to create a relatively homogenous mixture of the ingredients. It will be apparent that the amount of time for such mixing will depend on the total mass and volume to be mixed. The relatively homogenous mixture obtained at step 10 is then charged into a suitable extruder (e.g., twin-screw extruder) at step 12. In the extruder, the mixture is exposed to a first set of reaction conditions in one zone of the extruder to promote radical formation on the polymeric material but minimal radical formation on the radical scavenging ligand (primarily due to the radical scavenging ligand remaining in a solid state). The first reaction conditions include a sufficient temperature and dwell time in that zone to cause the polymeric material(s) to melt, but not the radical scavenging ligand(s), which minimizes the ability to radical scavenging ligand react in the first zone. Thereafter, the resulting reaction mixture is exposed to a second set of reaction conditions in another zone of the extruder to promote radical formation on the radical scavenging ligand and a subsequent radical substitution reaction, and direct bond formation between the polymeric material(s) and the radical scavenging ligand(s). The second reaction conditions include a sufficient temperature and dwell time in that zone to cause the entire mixture to melt.

Another exemplary method for making the active and/or intelligent packaging material is illustrated in FIG. 1B. This method differs from the method shown in FIG. 1A by virtue of the timing when the radical scavenging ligand(s) are introduced into the extruder at step 12; this method can be used if the melting point of the radical scavenging ligand(s) is not sufficiently higher than the melting point of the polymeric material(s). In step 10, the polymeric material(s) and radical initiator are introduced into a suitable mixing device and mixed for a sufficient period of time to create a relatively homogenous mixture of the ingredients. As noted above, the amount of time for such mixing will depend on the total mass and volume to be mixed. The relatively homogenous mixture obtained at step 10 is then charged into a suitable extruder (e.g., twin-screw extruder) at step 12. In the extruder, the mixture is exposed to a first set of reaction conditions in one zone of the extruder to promote radical formation on the polymeric material. The first reaction conditions include a sufficient temperature and dwell time in that zone to cause the polymeric material(s) to melt and radicals to form on the polymeric material. Thereafter, radical scavenging ligand(s) are introduced into the extruder and the resulting reaction mixture is exposed to a second set of reaction conditions in another zone of the extruder to promote radical formation on the radical scavenging ligand(s), a subsequent radical substitution reaction, and direct bond formation between the polymeric material(s) and the radical scavenging ligand(s). The second reaction conditions include a sufficient temperature and dwell time in that zone to cause the entire mixture to melt.

Importantly, direct bond formation surprisingly maintains the radical scavenging capacity of the covalently bound radical scavenging ligand (compared to the ungrafted radical scavenging ligand).

As will be appreciated by the skilled artisan, the specific temperature choices in the first and second zones will depend on the specific polymeric material(s) and radical scavenging ligand(s) that are selected. The dwell times may be optimized to maximize loading of the radical scavenging ligand(s) onto the polymeric material, but typically the dwell times will be from about 15 seconds up to about 10 minutes (such as 15 seconds up to about 5 or 6 minutes). Exemplary dwell times include, without limitation, from about 30 seconds to about 150 seconds, or from about 30 seconds to about 120 seconds. Extruding speeds can be at about 25 to about 350 rpm, such as about 40 to about 300 rpm, or about 50 to about 250 rpm, using any suitable feed rate (such as from about 5 to about 33% of the maximum feed rate). As will be appreciated by persons of skill in the art, the specific conditions (temperature, pressure, residence time, and extruder speed) will be selected for optimization of the reaction between the specific polymeric material(s), radical scavenging ligand(s), and radical initiators.

In both FIGS. 1A and 1B, the product obtained following the extrusion step 12 is the active and/or intelligent packaging material. The active and/or intelligent packaging material produced at extrusion step 12 is typically in the form of extruded strands, which are then cooled and introduced at step 14 to a pelletizer where the strands are then reduced in size to pellets (or nurdles) on the order of about 0.5 mm to about 2 mm (e.g., ˜1 mm). The pelletized form of the active and/or intelligent packaging material represents the industrial product, which end-product manufacturers will use in forming packaging materials, such as food packaging materials, that contain the active and/or intelligent packaging material, as discussed below.

Subsequent processing of the pelletized active and/or intelligent packaging material allows this raw material to be converted into a final commercial product, such as a food packaging material. Briefly, the active and/or intelligent packaging material is first melted and then the melted active and/or intelligent packaging material is formed into a shaped, food packaging material. The conditions during subsequent melting of the pellets involves heating to temperature to about 100° C. to about 230° C., preferably about 140° C. to about 200° C. or about 150° C. to about 190° C. As will be appreciated by persons of skill in the art, the specific conditions (temperature, residence time, and extruder speed) will be dependent on the particular properties of the active and/or intelligent packaging materials and the type of apparatus used for forming the packaging material.

As shown in FIGS. 1A and 1B, depending on the type of shaped, food packaging material being produced, the pelletized active and/or intelligent packaging material is processed on a film-forming apparatus 16 suitable to produce a single-layer film or multi-layer film by co-extrusion, extrusion coating, lamination, calendaring, etc.; or processed on a molding apparatus 18 suitable to produce a container or mating container components, such as a body and a lid, by injection molding, blow molding, extrusion molding, thermoforming, expanded bead blowing, etc.

For the film-forming apparatus 16, the pelletized active and/or intelligent packaging material is again introduced into an extruder which passes the melt through an appropriate slotted or annular die. Film-forming apparatus 16 can be a casting-type apparatus in which the cast film is cooled or quenched, and then wound up on a roll. Alternatively, the film-forming apparatus 16 can be a blown or tubular processing apparatus that forces air into an extruded ring to expand the film prior to annealing, and then the film can be wound on a roll.

Orientation in the direction of extrusion is known as machine direction orientation (MD), orientation perpendicular to direction of extrusion is known as transverse direction (TD). Orientation may be accomplished by stretching or pulling a blown film in the MD, using a blow-up ratio to accomplish TD orientation. Blown films or cast films may also be oriented by a tenter-frame orientation subsequent to the film extrusion process, again in one or both directions. Orientation may be sequential or simultaneous, depending upon the desired film features. Orientation ratios may generally be in the range of 1:3 to 1:6 in the machine direction (MD) or 1:4 to 1:10 in the transverse direction (TD). Preferred orientation ratios are commonly from between three to six times in the machine direction and between four to ten times the extruded width in the transverse direction.

For multi-laminar films, the layer containing the radical scavenging ligand is intended to be the side exposed to the food product. The outer layer may one or more coatings applied thereto, such as for barrier, printing, and/or processing. Such coatings commonly include acrylic polymers, such as ethylene acrylic acid (EAA), ethylene methyl acrylate copolymers (EMA), polyvinylidene chloride (PVDC), poly (vinyl) alcohol (PVOH), and ethylene (vinyl) alcohol EVOH. The coatings are preferably applied by an emulsion coating technique, but may also be applied by co-extrusion and/or lamination.

In one type of molding apparatus 18, the pelletized active and/or intelligent packaging material is again introduced into an extruder which passes the suitable melt into a mold body to produce a container or mating container components. After completion of the molding process, the mold itself is separated and the molded container (or component thereof) is removed from the mold and allowed to cool.

In another type of molding apparatus 18, the pelletized active and/or intelligent packaging material is stored with a foaming agent suitable to allow for swelling of the resin, and thereafter the swollen pellets are blown into a mold and sintered to form the container component(s). After completion of the molding process, the mold is separated, and the molded container (or component thereof) is removed from the mold and allowed to cool. Expanded bead blowing is typically used with polystyrene or polyethylene materials and a hydrocarbon (e.g., butane or pentane) as the foaming agent, although other materials can also be prepared in this manner, including polyamide resins foamed with carbon dioxide (Yeh et al., “Carbon Dioxide-Blown Expanded Polyamide Bead Foams with Bimodal Cell Structure,” Ind. Eng. Chem. Res. 58 (8): 2958-2969 (2019), which is hereby incorporated by reference in its entirety).

In alternative embodiments, the extrusion apparatus used at step 12 (producing the ligand-grafted polymer) could be integrated directly with a film-forming apparatus 16 or molding apparatus 18, thereby avoiding the step of preparing the intermediate pelletized form of the active and/or intelligent packaging material.

In addition to the foregoing, the use of the pelletized active and/or intelligent material to form blended polymer materials is contemplated. By way of example, the pellets of the active and/or intelligent material obtained at step 14 of FIGS. 1A-B can be mixed and re-extruded with a secondary polymer to tailor the properties of the final blended product while maintaining the ability of the blended product to behave as an active and/or intelligent material. By way of example only, low density polyethylene (LDPE) can be blended with the PP-g-Cur material to afford more flexible properties; or starch can be blended with PP-g-Cur material to afford a partially biodegradable product. That blending can be achieved while retaining the active and/or intelligent properties is confirmed by the blended PP-g-Cur/PP-g-MA product described in the accompanying Examples.

As noted above, a further aspect relates to an active and/or intelligent food-grade packaging or container that is prepared from one of the active and/or intelligent packaging materials disclosed herein. In its basic form, the active and/or intelligent, food-grade packaging or container includes a body having a food contact surface and an external surface. Because of the reactive extrusion process employed, the body includes a polymeric material having covalently attached thereto a ligand (as described above) where the radical scavenging ligand is present on both the food contact surface and on the external surface (or surface facing away from the food contact surface). The radical scavenging ligand is also covalently bound to the polymer backbone between these surfaces, although that fraction is not surface exposed.

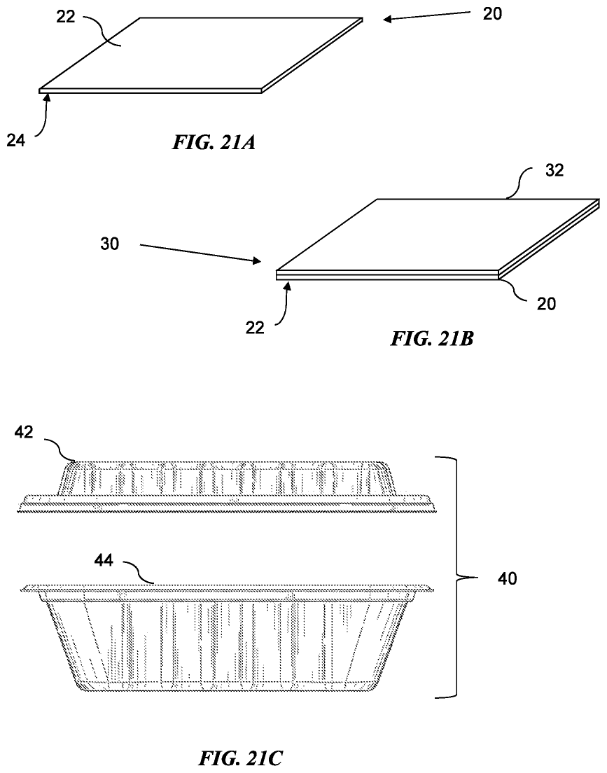

In one embodiment, illustrated in FIG. 21A, the active and/or intelligent food-grade packaging is a single-layer sheet of film 20. The film 20 has ligand exposed on both its food contact surface 22 (upper side in FIG. 21A) and on the external surface 24 (lower side in FIG. 21A).

In another embodiment, illustrated in FIG. 21B, the active and/or intelligent food-grade packaging is a multi-layer sheet of film 30 (dual layer as shown), which is formed with a first layer of film 20 prepared using one of the active and/or intelligent packaging materials disclosed herein and including a food contact surface 22 (lower side in FIG. 21B). The sheet of film 30 also contains a second layer of film 32 which is present on the side of film 20 facing away from the food contact surface 22.

It will be appreciated by persons of skill in the art that film 20 and film 30 are illustrative, and that the film can be in the form of a roll of film, an individual plastic bag, or a tube. In these embodiments, the film or bag may include the active, food-grade packaging material as one of several components. Alternatively, the film or bag may be formed entirely, or substantially entirely, from the active and/or intelligent packaging material as disclosed herein. One form of a bag that is substantially entirely formed of the active and/or intelligent packaging material is a bag having a resealable closure mechanism where the body of the bag is formed of the active and/or intelligent packaging material but the resealable closure mechanism is not.

In a further embodiment, illustrated in FIG. 21C, the active and/or intelligent packaging material is a food storage container 40 that includes two component parts, lid 42 and container body 44. The lid 42 and container body 44 are formed to have a sealed snap-fit arrangement allowing the container 40 to have an air-tight seal. In one configuration, the container body 44 is the only component prepared using one of the active and/or intelligent packaging materials disclosed herein. In another configuration, both the lid 42 and container body 44 are prepared using one of the active and/or intelligent packaging materials disclosed herein. The active and/or intelligent packaging material used for the lid 42 and body 44 can be the same or different; if different, the radical scavenging ligand used in the active and/or intelligent packaging material that forms the lid can be different from the radical scavenging ligand used in the active and/or intelligent packaging material that forms the container body.

Regardless of the specific configuration, the lid 42 and container body 44 have their respective food contact surfaces facing the interior of the container 40, although the radical scavenging ligand is present on both the food contact surface and on the external surfaces of the container 40 when those components are formed of a single polymeric material, i.e., active and/or intelligent packaging materials as disclosed herein.

Alternatively, the lid 42 and container body 44 may optionally have a multi-laminar construction such that a first polymeric material forms the bulk of the shaped component and a second polymeric material—an active and/or intelligent packaging material disclosed herein-forms an interior surface or lining on that component, whereby the entirety of the food contact surfaces is formed of the active and/or intelligent packaging material.

Although the container 40 is shown as a two-component container, it should be appreciated by persons of skill in the art that the container could be a clam-shell type container, a container body 44 alone which is adapted for being sealed with a film of the invention or otherwise, or a beverage container or jug.

In the above embodiments, it is contemplated that both the film 20 of FIG. 21A, the multi-layer film 30 of FIG. 21B, and the container 40 of FIG. 21C (i.e., either one or both of its components) can be formed of one of the active and/or intelligent, food-grade packaging materials as described herein, including (i) PP-g-Cur (FIG. 2), (ii) starch-g-Cur (FIG. 3), and (iii) PLA-g-Cur (FIG. 4). As discussed above, in each of these embodiments, the specific ligand (Curcumin) is exposed on both the intended food contact surfaces and non-food contact surfaces, as well as covalently bound to the polymer backbone within the interior (or bulk) of the film and container components.

In use, the disclosed active, food-grade packaging materials are intended to be used to package perishable food items by sealing a perishable food item in a package that includes an active, food-grade packaging material as described herein, whereby the food contact surface of the active packaging material, and the radical scavenging ligand thereon, contacts the perishable food item to reduce food spoilage while remaining covalently bound to the polymeric material. The package may include any known forms, shapes, or configurations, several of which are illustrated in FIGS. 21A-C. Liquid storage containers or jugs are also contemplated.

As used herein, “reduce food spoilage” is intended to mean that the process of spoilage is inhibited and, thus, delayed relative to the same food stored in a comparable food-grade packaging material lacking the active ligand. Inhibition and delay of food spoilage can be measured in any of a variety of ways, which are well known in the art, including sensory evaluation (measurement of degradation products), gas production and packaging bloating, or microbial count.

It is contemplated that the active packaging material as disclosed herein can be used with a wide range of food products, i.e., breads, meats, fish, fruits and vegetables as well as juices prepared therefrom, and cheese, milk, and other dairy products.

In storing perishable food items in contact with the active packaging material, it is preferable that the radical scavenging ligand exhibits little or no migration from the packaging material into the food product. Based on the covalent attachment of the radical scavenging ligand to the polymeric material, it is fully expected that the radical scavenging ligand is non-migratory in this respect.

In carrying out the storage of perishable food items in accordance with the present invention, it is also contemplated that the use of the active packaging material can be combined with other food preservation packaging techniques and materials, including the use of a sachet inside the package which contains any of one or more known types of oxygen scavengers, the use of vapor phase packaging environments that inhibit growth of spoilage organisms, etc.

In addition to the use of the active and/or intelligent material in food packaging materials, is should be understood that these materials are not limited to use in food packaging. Other uses of the active and/or intelligent materials include, without limitation, application as coatings or copolymers used on floors, pipes, drains, and medical devices.

Wherever the word ‘about’ is employed herein in the context of amounts, for example absolute amounts, or relative amounts such as concentrations and ratios, time frames, and parameters, such as such as temperature, pressure, weight percentage, dimension, etc., it will be appreciated that such values are approximate and as such may vary by ±10%, for example±5% and preferably ±2% (e.g. ±1%) from the actual numbers specified herein. This is the case even if such numbers are presented as percentages in the first place (for example ‘about 10%’ may mean±10% about the number 10, which is anything between 9% and 11% inclusive thereof).

As used herein, “consisting essentially of” means that a composition includes the recited components as well as any additional components that are present in inconsequential amounts (e.g., less than about 0.5 wt %, 0.4 wt %, 0.3 wt %, 0.2 wt %, or 0.1 wt %) or additional components that may be present in larger amounts but despite their presence do not materially alter the behavior of the polymeric material, ligand, and/or initiator in forming the active and/or intelligent packaging material or active and/or intelligent food-grade packaging made therefrom.

### Examples

The examples below are intended to exemplify the practice of embodiments of the disclosure but are by no means intended to limit the scope thereof.

### Materials for Examples 1-3

L-ascorbic acid, curcumin (cat no. 8.20354, CAS no. 458-37-7), 2,2-Diphenyl-1-picrylhydrazyl (DPPH), ethylenediaminetetraacetic acid calcium disodium salt (EDTA), glacial acetic acid, hydrochloric acid (trace-metal grade), (±)-6-hydroxy-2,5,7,8-tetramethylchromane-2-carboxylic acid (Trolox, 97%), imidazole (99%), polypropylene-graft-maleic anhydride (PP-g-MA) pellets (maleic anhydride 8-10 wt. %, cat no. 427845, CAS no. 25722-45-6), potassium persulfate (≥99%), sodium acetate trihydrate, sodium phosphate dibasic heptahydrate, and sodium phosphate monobasic monohydrate were purchased from Millipore Sigma (Burlington, MA). 2,2′-azino-bis (3-ethylbenzothiazoline-6-sulfonic acid) diammonium salt (ΔBTS, 98%) and sodium hydroxide were purchased from Fisher Scientific (Fair Lawn, NJ). Dicumyl peroxide (DCP) was purchased from Krackeler Scientific (Δlbany, NY) and ground into a fine powder using a mortar and pestle. Ethanol (200 proof) was procured from Decon Labs (King of Prussia, PA). Corn oil was purchased from Amazon (Seattle, WA). Polypropylene (PP) pellets (isotactic, cat no. 130, CAS no. 9003-07-0) were obtained from Scientific Polymer (Ontario, NY, USA). Grades U, E, and EX purge for the extruder were generously provided by Asahi Kasei Asaclean Americas (Parsippany, NJ, USA). All reagents were used as received without further purification.

### Example 1-Synthesis and Characterization of Curcumin-Grafted Polypropylene (PP-g-Cur)

To facilitate homogenization of polymer pellets and reagent powders, isotactic PP and PP-g-MA were blended as described previously (Redfearn et al., “Antioxidant and Dissociation Behavior of Polypropylene-Graft-Maleic Anhydride,” J Appl Polym Sci. 139 (32): e52764 (2022), which is hereby incorporated by reference in its entirety). Briefly, PP was mechanically mixed with 50% w/w PP-g-MA and fed into a Process 11 Parallel Twin Screw Extruder (Thermo Fisher Scientific, Waltham, MA, USA) through an attached volumetric feeder (11 mm volumetric single screw feeder for process 11 [MK2] by Thermo Electron, Germany) at 7% the maximum rate. Isotactic PP without blending was also prepared as a control for all analyses. The pellets were processed at 250 rpm through a 1.5 mm die using the following temperature profile: Zone 2—140° C., Zone 3—180° C., Zone 4—180° C., Zone 5—180° C., Zone 6—180° C., Zone 7—180° C., Zone 8—180° C., and 190° C. at the die. The extruded polymer filament was fed into a Vericut Pelletizer (ThermoFisher Scientific, Waltham, ME) using the L1 setting to form 0.5 mm granules of blended PP and PP-g-MA. Granules were stored over anhydrous calcium sulfate desiccant for at least 24 hours prior to further processing. To obtain polymer films, 1.5 g of polymer granules were placed in a single layer between two 5 mil Kapton films (Cole-Parmer, Vernon Hills, IL) and allowed to melt in a Fortin CRC Prepreg Mini Test Press at 180° C. for 2 minutes. Films were then pressed for 30 seconds to a thickness of 0.22±0.04 mm and stored under calcium sulfate desiccant for at least 24 hours. Films were immersed in absolute ethanol and shaken at 150 rpm for 2 hours to wash any contaminants and un-grafted curcumin. Films were dried with filtered compressed air and stored over anhydrous calcium sulfate desiccant until further analysis. From this point forward, 50:50 w/w blended PP-g-MA: PP films and pellets will be referred to as simply PP-g-MA. Pure PP extruded, pelletized, pressed, and washed from this process will be referred to as PP and was used as the control for all experiments (see Table 1).

TABLE 1
Concentration (weight percent) of PP-g-MA, DCP,
and curcumin in final films. Remaining weight percent
is comprised of extruded and pelletized PP

| | PP-g-MA % | DCP % | Curcumin % |
|---|---|---|---|
| Sample ID | (w/w) | (w/w) | (w/w) |
| PP | 0 | 0 | 0 |
| PP-g-MA/PP | 25 | 0 | 0 |
| PP-g-Cur1 | 0 | 0.5 | 1 |
| PP-g-Cur2 | 0 | 0.5 | 2 |
| PP/Cur1 | 0 | 0 | 1 |
| PP/Cur2 | 0 | 0 | 2 |
| PP-g-MA/PP-g-Cur1 | 25 | 0.25 | 0.5 |
| PP-g-MA/PP-g-Cur2 | 25 | 0.25 | 1 |
| PP-g-MA/PP/Cur1 | 25 | 0 | 0.5 |
| PP-g-MA/PP/Cur2 | 25 | 0 | 1 |

Granulated PP (described above), dicumyl peroxide (DCP), and curcumin were used to synthesize antioxidant PP-g-Cur via radical grafting in the melt by reactive extrusion as illustrated in FIG. 2. DCP was received as large pellets, which were homogenized into a fine powder using a mortar and pestle and stored at 4° C. until further use. Granulated PP was mechanically mixed with 0.5% w/w powdered DCP and either 1% or 2% w/w curcumin and fed into a Process 11 Parallel Twin Screw Extruder (Thermo Fisher Scientific, Waltham, MA, USA) through an attached volumetric feeder (11 mm volumetric single screw feeder for process 11 [MK2] by Thermo Electron, Germany) at 18% the maximum rate. Mixtures containing 1% and 2% w/w curcumin and granulated PP without DCP were also extruded as controls for the radical grafting reaction. The mixtures were processed at 150 rpm through a 1.5 mm die using the following temperature profile: Zone 2—145° C., Zone 3—160° C., Zone 4—165° C., Zone 5—170° C., Zone 6—175° C., Zone 7—175° C., Zone 8—175° C., and 185° C. at the die. It is important to note the mixing elements of the extruder were placed in Zones 3, 4, and 6, with the rest of the zones containing conveying elements. Extruded samples were pelletized, pressed, washed, and stored as described for granulated PP and PP-g-MA. Nomenclature for these samples is as follows: PP-g-CurX for samples processed with DCP and PP/CurX for samples processed without DCP, in which X refers to the weight percentage of curcumin and slashes indicate unreacted (melt blended without radical grafting) blends (see Table 1).

PP-g-MA was used as a compatibilizer to improve the optical and interfacial properties of PP-g-Cur. Granulated PP-g-MA was mechanically mixed with 50% w/w PP-g-CurX or PP/CurX (as a control for the radical grafting reaction) and extruded under the conditions described above for PP-g-Cur. To determine the impact of maleic anhydride (MA) on functional and physical properties, blends containing 50% w/w granulated PP with 50% w/w granulated PP-g-MA were also extruded under the same conditions. All extruded samples were pelletized, pressed, washed, and stored as described for granulated PP and PP-g-MA. Nomenclature for these blended samples is as follows: PP-g-MA/PP, PP-g-MA/PP-g-CurX, and PP-g-MA/PP/CurX, where X refers to the weight percentage of curcumin and slashes indicate unreacted blends. The final compositions of all samples are listed (see Table 1).

The thicknesses of all films were measured using a Snapthick (iGaging®, San Clemente, CA) 3-Way Digital Electronic Thickness Gauge accuracy of 0.02 mm. Measurements were taken on a single random location on each of three independent films from each of two independent batches per sample.

### Example 2-Characterizing the Interfacial, Chemistry, Thermal, and Optical Properties of PP-g-Cur

ATR-FTIR using an IRPrestige FTIR spectrometer equipped with a diamond ATR crystal (Shimadzu Scientific Instruments Inc., Kyoto, Japan) was used to identify characteristic functional groups of each sample. Spectra were taken from the average of 32 scans using Happ-Genzel apodization and 4 cm⁻¹ resolution with air as the background spectrum. Spectra of samples containing curcumin were compared against PP and PP-g-MA/PP negative controls. Origin Pro 2021b was used to baseline correct and graph all spectra. FTIR analysis was performed on two independent spots on each of two independent coupons for each of two independently prepared batches per sample. A random number generator was used to pick one of the eight collected spectra for each sample for reporting here.

The advancing contact angle, receding contact angle, and hysteresis values for treated and control films were analyzed using an Attention Theta Optical Tensiometer (Biolin Scientific, Stockholm, Sweden) based on methods previously reported (Herskovitz et al., “Antioxidant Functionalization of Biomaterials via Reactive Extrusion,” J Appl Polym Sci. 138 (25): 50591 (2021), which is hereby incorporated by reference in its entirety) with minor adjustments. Briefly, advancing contact angle (Δ) was performed by depositing a deionized water droplet of ˜4 μL on the surface of each film. The syringe was inserted into the center of the droplet, and the size of the droplet was increased at a rate of 0.5 μL/s with images being recorded at 14 frames per second. Contact angle was analyzed using the Young-Laplace method and advancing contact angle was defined as the maximum stabilized mean contact angle prior to droplet's baseline advancing. Similarly, receding contact angle (OR) was measured by reinserting the needle into the expanded droplet from the advancing contact angle procedure and decreasing the size of the droplet at a rate of 0.5 μL/s. Contact angle was recorded and analyzed using the same parameters as advancing but with the receding contact angle defined as the maximum stabilized mean contact angle prior to the droplet's baseline receding. Contact angle hysteresis was calculated as the difference between advancing and receding contact angle for each measurement. All measurements were performed on two different spots of two different coupons from two independently extruded batches of each sample (totaling 8 measurements per treatment).

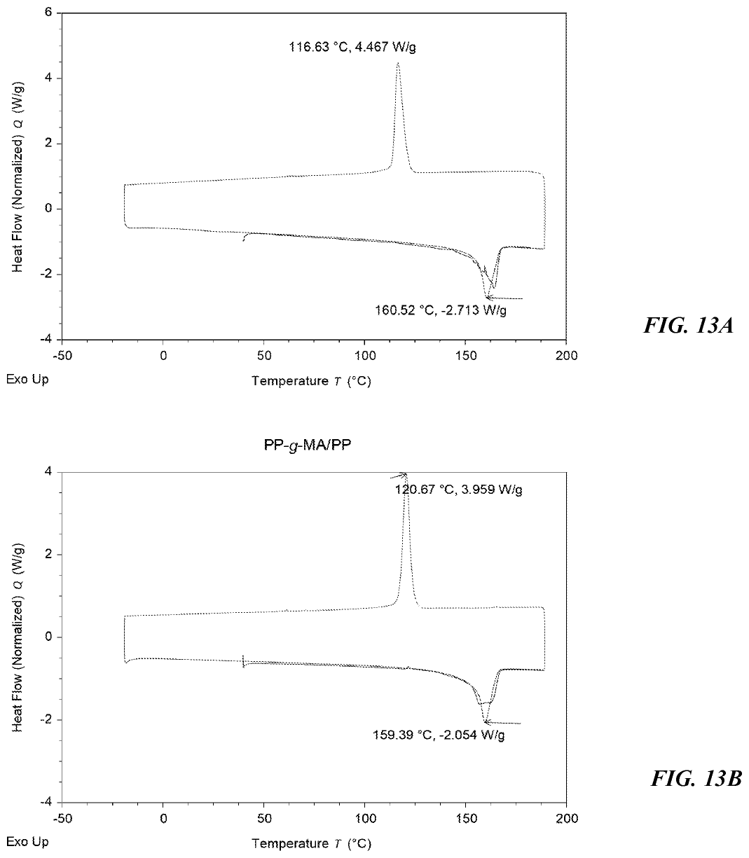

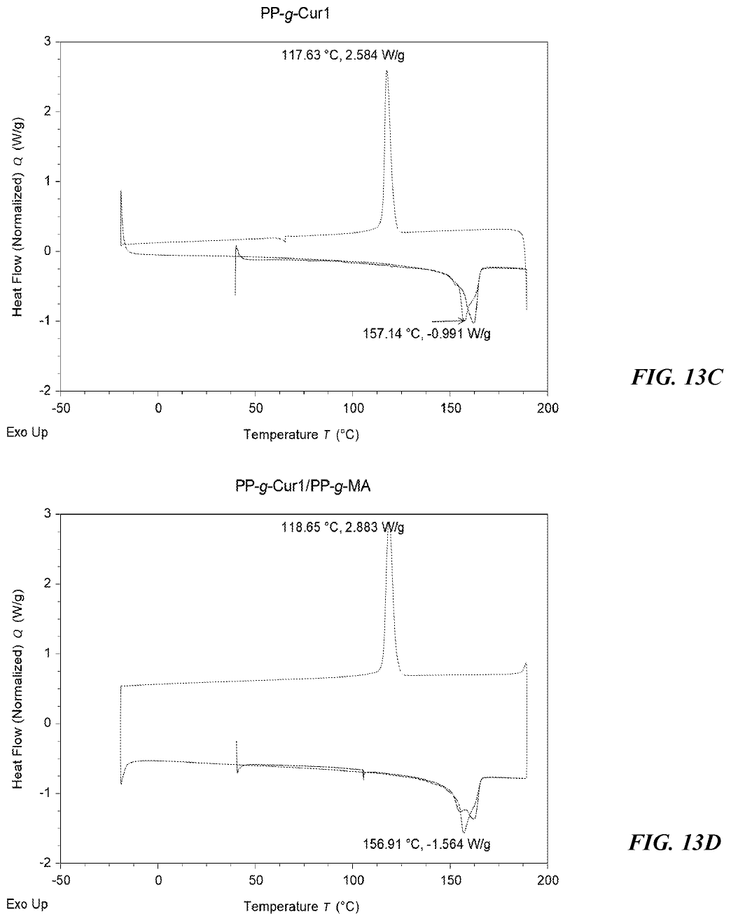

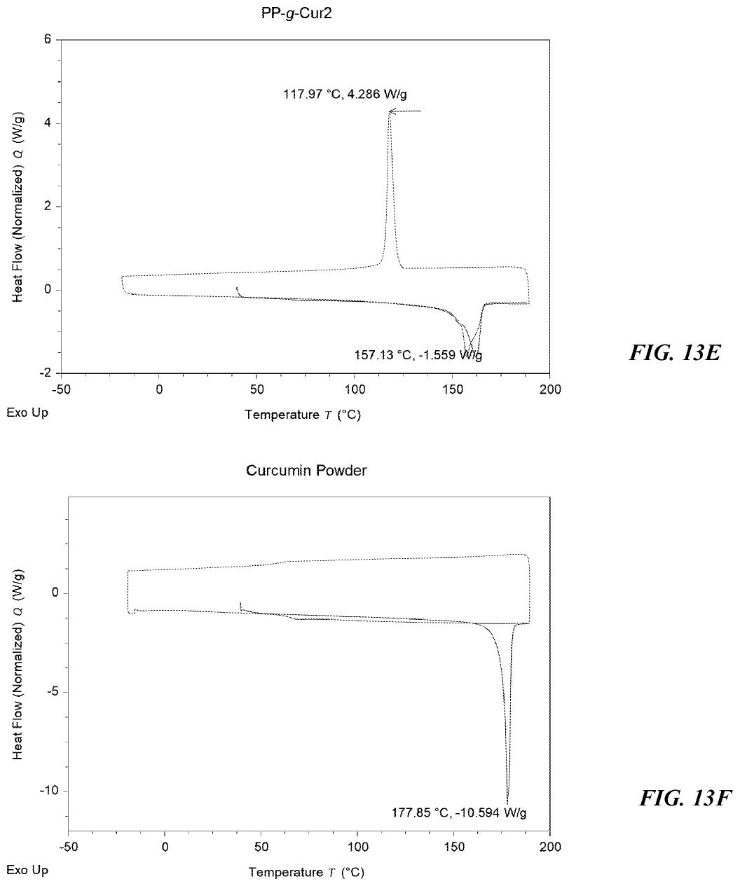

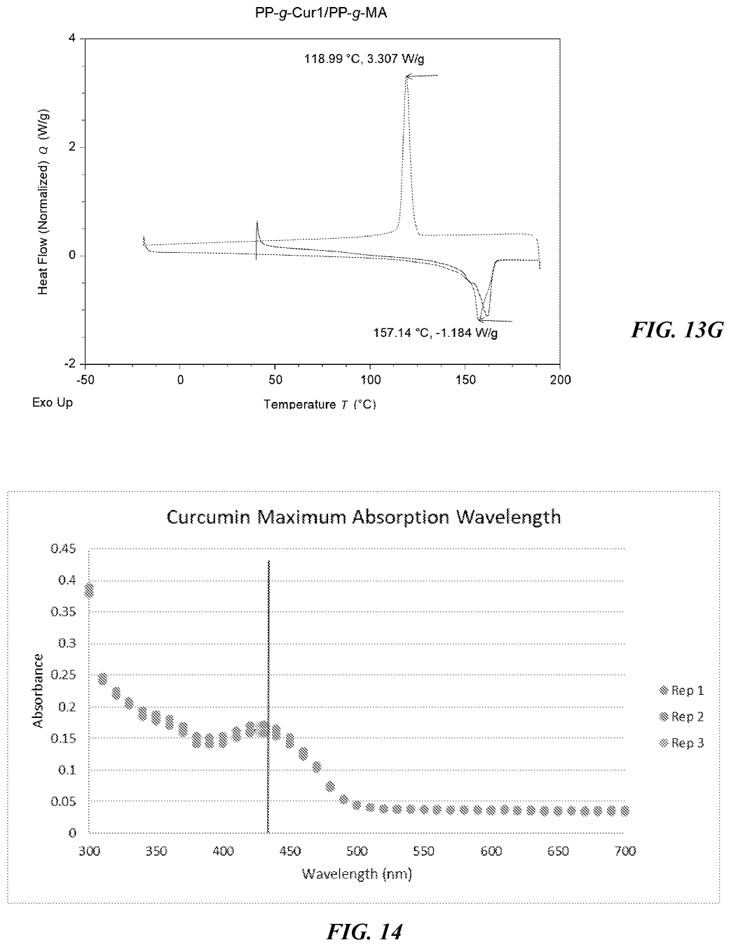

Thermogravimetric analysis (TGA 5500, TA Instruments, New Castle, DE, USA) was used to measure the thermal stability of polymers and curcumin powder (FIG. 12). All samples were placed in a platinum pan and heated to 600° C. at a rate of 10° C./min under nitrogen. Modulated differential scanning calorimetry (DSC 2500, TA Instruments, New Castle, DE, USA) was used to determine the thermal properties of control and treated samples as well as curcumin powder (FIG. 13). A heat-cool-heat method was used on samples sealed in aluminum pans, with an empty aluminum pan used as a reference. All samples were heated to a maximum temperature of 190° C. and cooled to a minimum temperature of −20° C. at a rate of 10° C./min. TRIOS 5.1.1 software (TA Instruments, New Castle, DE, USA) was used to analyze the melting, crystallization, and thermal degradation temperatures of each sample. Thermal analyses were performed for only one representative sample of each treatment.

The migration of curcumin into food simulants was analyzed using a method based on recommendations from the FDA (USFDA, “Guidance for Industry: Preparation of Premarket Submissions for Food Contact Substances (Chemistry Recommendations),” (2018) (Δvailable from: https://www.fda.gov/regulatory-information/search-fda-guidance-documents/guidance-industry-preparation-premarket-submissions-food-contact-substances-chemistry #ai), which is hereby incorporated by reference in its entirety) and EU (EU. Commission Regulation (EU) No Oct. 20, 2011 on “Plastic Materials and Articles Intended to Come into Contact with Food,” Official Journal of the European Union 045:42-130 (2011), which is hereby incorporated by reference in its entirety). Sample coupons (2 cm2) were placed in glass headspace vials along with 10 mL of food simulant. The simulants used were deionized water (aqueous foods), 3% acetic acid (acidic foods), 10% ethanol (low alcohol foods), 50% ethanol (lipophilic foods), and 95% ethanol (fatty foods) to represent a range of applications. Each headspace vial was sealed with a polytetrafluoroethylene-butyl (PTFE-butyl) septum and crimp-top aluminum seal and incubated at 40° C. for 10 days. After incubation, aliquots were taken from each vial and analyzed on a Synergy Neo2 Hybrid Multi-Mode Reader (BioTek Instruments, Winooski, VT) at 428 nm, which was experimentally determined to be the maximum absorbance wavelength for curcumin (FIG. 14). The amount of curcumin migrated from each sample was determined by comparison to curcumin standard curves made in each food simulant, with each food simulant acting as the respective blank. All standard curves were made in triplicate using a stock solution of 0.1 mg/mL curcumin in absolute ethanol that was diluted into each simulant. The amount of curcumin migration was compared to the limit of migration for packaging constituents listed by the European Union (10 mg/100 cm²) (EU. Commission Regulation (EU) No Oct. 20, 2011 on “Plastic Materials and Articles Intended to Come into Contact with Food,” Official Journal of the European Union 045:42-130 (2011), which is hereby incorporated by reference in its entirety). Migration analysis was performed in quadruplicate for each of two independently extruded batches of each treatment.

The UV-barrier and visible light transmission properties of control and treated films were analyzed using a method adapted from Roy et al (Roy et al., “Carboxymethyl Cellulose-Based Antioxidant and Antimicrobial Active Packaging Film Incorporated with Curcumin and Zinc Oxide,” Int J Biol Macromol. 148:666-76 (2020), which is hereby incorporated by reference in its entirety). Polymer samples were hole-punched using a standard hand-held ¼ -inch hole puncher and placed in a clear-bottomed 96-well plate. The absorbance of each sample was analyzed from 230 to 800 nm with 2 nm resolution on a Synergy Neo2 Hybrid Multi-Mode Reader (BioTek Instruments, Winooski, VT). The absorbance values of blank wells were subtracted from sample absorbance values, which were then converted to percent transmission and plotted against wavelength. Optical analysis was averaged from two independent coupons from two independently extruded batches (totaling 4 replicates per treatment).

### Example 3-Demonstrating the Intelligent and Active Properties of PP-g-Cur Radical Scavenging Assays

The antioxidant performance of control and treated polymers was determined using 2,2-diphenyl-1-picrylhydrazyl radical (DPPH·) and 2,2′-azino-bis (3-ethylbenzothiazoline-6-sulfonic acid) (ΔBTS·+) assays adapted from previous work (Roy et al., “Carboxymethyl Cellulose-Based Antioxidant and Antimicrobial Active Packaging Film Incorporated with Curcumin and Zinc Oxide,” Int J Biol Macromol. 148:666-76 (2020); Herskovitz et al., “Reactive Extrusion of Nonmigratory Antioxidant Poly (Lactic Acid) Packaging,” J Agric Food (hem. 68 (7): 2164-73 (2020); which are hereby incorporated by reference in their entirety). The DPPH assay was performed by incubating 1×1 cm² coupons in 0.5 mL DPPH solution (0.1 mM in ethanol) mixed with 0.5 mL ethanol in a 24-well plate. Coupons were incubated for 24 hours at 25° C. in the dark with shaking at 150 rpm. After incubation the absorbance of each solution was read on a Synergy Neo2 Hybrid Multi-Mode Reader (BioTek Instruments, Winooski, VT) at 517 nm and compared against a Trolox standard curve (0-40 μM) in ethanol. For the ABTS assay, a 1:1 volumetric mixture of 7 mM ABTS in 4 mM sodium phosphate buffer (pH 7.4, adjusted with hydrochloric acid and sodium hydroxide) and 2.45 mM potassium persulfate in sodium phosphate buffer, pH 7.4, was reacted for 16 hours in the dark at room temperature (˜20° C.) to create the radical stock solution. The stock solution was diluted with either ethanol or 4 mM sodium phosphate buffer (pH 7.4) (organic and aqueous, respectively) to an absorbance of 0.900±0.30 at 734 nm to produce the ABTS working solution. In a 24-well plate, 1×1 cm² coupons of each film were incubated with 0.5 mL organic ABTS working solution and 0.5 mL ethanol or 0.5 mL aqueous ABTS working solution and 0.5 mL 4 mM sodium phosphate buffer (pH 7.4) for organic and aqueous ABTS assays, respectively. The plate was incubated at 30° C. for 4 hours for the organic solution and 24 hours for the aqueous solution. The absorbance of each well was analyzed on a Synergy Neo2 Hybrid Multi-Mode Reader (BioTek Instruments, Winooski, VT) at 734 nm and converted to TEAC using a Trolox standard curve (0-40 uM) made in either ethanol or 4 mM sodium phosphate buffer (pH 7.4). For both the DPPH and ABTS assays, the average Trolox equivalent antioxidant capacity (TEAC) of the blank wells (containing no coupons) was subtracted from the TEAC values of each sample to account for any color degradation of the DPPH or ABTS solution during incubation. ABTS assays were performed in duplicate on quadruplicate coupons from each of two independently extruded batches of each treatment (totaling 16 replicates per treatment), and DPPH assays were performed in duplicate on triplicate coupons from each of two independently extruded batches of each treatment (totaling 12 replicates per treatment).

The ability of treated and control PP to inhibit the oxidative degradation of ascorbic acid was quantified using a method adapted from previous work (Herskovitz et al., “Reactive Extrusion of Nonmigratory Antioxidant Poly (Lactic Acid) Packaging,” J Agric Food Chem. 68 (7): 2164-73 (2020), which is hereby incorporated by reference in its entirety). In brief, 1×1 cm² coupons of each sample were incubated in glass GC vials with aluminum septum caps. The vials were filled with 1 mL 20 mM ascorbic acid in 10 mM sodium acetate imidazole buffer (pH 4.0, adjusted with HCl) and incubated for 9 days at 37° C. Concentration of ascorbic acid was measured on days 1, 3, 5, 7, and 9 using a modified version of the Association of Official Analytical Chemists method 967.21.38 (Horwitz, “Association of Official Analytical Chemists: Official methods of analysis of the Association of Official Analytical Chemists,” Washington, DC: The Association (1970), p. 5, which is hereby incorporated by reference in its entirety). Aliquots of 20 μL from each vial were combined with 480 μL of 0.04 wt % oxalic acid (in water) in 1-mL Eppendorf tubes and vortexed until well mixed. Aliquots of 30 μL from this solution were combined with 470 μL 0.2 mM dichloroindophenol (in water) in 1-mL Eppendorf tubes and vortexed until well mixed. The absorbance of the dichloroindophenol mixtures were immediately measured on a Synergy Neo2 Hybrid Multi-Mode Reader (BioTek Instruments, Winooski, VT) at 520 nm and converted to ascorbic acid concentrations using an ascorbic acid standard curve (0-20 mM). The ascorbic acid concentration of each sample over time was fit with a single-phase decay model. The assay was performed on quadruplicate coupons from two independently extruded batches, totaling 8 replicates per treatment.

The Japanese Industrial Standard (JIS) Z2801: 2000 method was slightly modified to analyze antibacterial activity of treated films against food-borne pathogenic bacteria (Association JS., “Antimicrobial products: Test for Antimicrobial Activity and Efficacy,” Japanese Industrial Standard JIS Z 2801 (2000), which is hereby incorporated by reference its entirety). Briefly, a culture of E. coli ATCC strain no. 25922 and a culture of L. monocytogenes from a food isolate were stored in 20% glycerol at −80° C. until use. The L. monocytogenes strain was obtained from the Cornell Food Safety Laboratory Bacterial Strains Collection as FSL C1-0053 and originally isolated from a finished ready-to-eat dairy food product. The cultures were streaked on tryptic soy agar (TSA) and incubated at 37° C. for E. coli and 30° C. L. monocytogenes for 24 hours. An isolated colony from each plate was used to inoculate 12 mL of tryptic soy broth (TSB), which was incubated with shaking for 24 hours at 37° C. A 100 μL aliquot of each culture was used to inoculate 50 mL TSB, which was incubated with shaking for 24 hours at 37° C. to achieve a cell density of 109 CFU/mL, which was confirmed by plate count on TSA. Each culture was diluted to reach a starting concentration of 105 CFU/mL, also confirmed by plate count on TSA. Treated films were cut into 5×5 cm² squares and stored in sterile conditions after the ethanol wash described in the synthesis step. A 0.4 mL aliquot of each 105 CFU/mL culture was placed on the treated films and covered with a 4×4 cm² sterile PP film to create a sandwich. The PP cover was lightly pressed down with sterile tweezers to distribute the inoculum across the treated film and the sandwich was placed in a Petri dish. The Petri dish was placed in an airtight box containing paper towels saturated with 100 mL of filtered water to maintain a humid environment. The entire apparatus was incubated at 37° C. for 24 hours. After incubation, 10 mL of phosphate buffered saline (PBS, pH 7.4) solution was pipetted into each Petri dish and well mixed to disassemble the sandwich and dilute the inoculated broth. An aliquot was taken from each Petri dish and serially diluted with PBS buffer. A 100 μL aliquot of the appropriate dilution was plated in duplicate on TSA and incubated for 24 hours at 37° C. Plates with 30-300 CFU were counted, and the average plate count of the duplicate plates was recorded. Plate counts for treated films were subtracted from the average plate count of the control to determine inhibition of bacterial growth. The assay was performed on triplicate coupons from two independently extruded batches, totaling 6 replicates per treatment.

To determine the antimicrobial performance of free curcumin, the assay was repeated with curcumin powder added to the starting inoculum. Curcumin powder was first completely dissolved in ethanol to prepare 2 mg/mL and 0.2 mg/mL stock solutions. Stock solutions were diluted 10× in TSB to final concentrations of 200 μg/mL and 20 μg/mL curcumin, which was then inoculated to a 105 CFU/mL starting concentration of either E. coli or L. monocytogenes, confirmed by plate count. The procedure was repeated by replacing the curcumin stock solutions with absolute ethanol (10% v/v in TSB) to quantify any growth inhibition due to ethanol. A 0.4 mL aliquot of each 10⁵ CFU/mL starting inoculum was placed on 5×5 cm² sterile PP films and covered with a 4×4 cm² sterile PP film to create a sandwich, and the assay was repeated as described above. The assay on free curcumin powder was performed in triplicate for each stock solution.

The color changing properties of treated films were demonstrated using a method adapted from previous work (Yildiz et al., “Monitoring Freshness of Chicken Breast by Using Natural Halochromic Curcumin Loaded Chitosan/PEO Nanofibers as an Intelligent Package,” Int J Biol Macromol. 170:437-46 (2021); Cvek et al., “Biodegradable Films of PLA/PPC and Curcumin as Packaging Materials and Smart Indicators of Food Spoilage,” AC'S Applied Materials & Interfaces 14 (12): 14654-67 (2022), which are hereby incorporated by reference in their entirety). Films were cut into 1.3×1.3 cm coupons and attached to the inside of PTFE-butyl septa using Kapton double-sided tape. The septa were placed in aluminum caps and crimped to 10 mL glass headspace vials filled with 9 mL 0.8 mM ammonia. Coupons were left to incubate at room temperature (22° C.) for 24 hours. After incubation the coupons were removed from the septa and immediately analyzed with a CR-400 Chroma Meter (Konica Minolta Sensing, Ramsey, NJ) using CIELab color space parameters. The color space parameters of the coupons prior to ammonia exposure were also recorded. Total color change (ΔE*, Equation 1) and the chromatic parameter (ΔC*, Equation 2) of each treated film were calculated,

$$Δ {E}^{*} = \sqrt{{( {L}_{1}^{*} - {L}_{2}^{*} )}^{2} + {( {a}_{1}^{*} - {a}_{2}^{*} )}^{2} + {( {b}_{1}^{*} - {b}_{2}^{*} )}^{2}} \qquad ( 1 )$$

$$Δ {C}^{*} = \sqrt{{( {a}_{1}^{*} - {a}_{2}^{*} )}^{2} + {( {b}_{1}^{*} - {b}_{2}^{*} )}^{2}} \qquad ( 2 )$$

where L* represents lightness, a* represents redness/greenness, and b* represents blueness/yellowness. Digital photographs of each coupon were taken in a light box before and after incubation to show visible color change. This assay was performed on triplicate coupons from two independently extruded batches, totaling 6 replicates per treatment. Images presented in the results were randomly selected using a random number generator across replicates and a square crop of each photo was taken to maximize the area shown.

Extrusion of all films was performed in duplicate batches on two independent days, and all results are equally representative of both batches. All data was analyzed for normality using the Shapiro-Wilk test on GraphPad Prism 9.3.0 (La Jolla, CA). Statistical significance for water contact angle, color change response to ammonia, radical scavenging assays, and antibacterial properties was analyzed using analysis of variance (ΔNOVA) with Tukey's HSD multiple comparisons (p<0.05). Statistical significance for the migration assay was analyzed using ANOVA with Dunnett's HSD compared to control PP on GraphPad Prism 9.3.0 (La Jolla, CA). Migration data for 50% EtOH and 95% EtOH simulants followed a lognormal distribution, so ANOVA with Dunnett's HSD was performed on the log values for those simulants to determine statistical significance.

### Discussion of Examples 1-3

Peroxide-initiated radical grafting reactions are one of the most common strategies used to modify PP to increase material compatibility, adhesion, and functionalization (Shi et al., “Functionalization of Isotactic Polypropylene with Maleic Anhydride by Reactive Extrusion: Mechanism of Melt Grafting,” Polymer 42 (13): 5549-57 (2001), which is hereby incorporated by reference in its entirety). The reaction begins by the thermal decomposition of the peroxide into alkoxy radicals, which subsequently abstract a hydrogen from the tertiary carbon of the PP or a phenolic hydrogen from the curcumin to form a macroradical (Moad, “The Synthesis of Polyolefin Graft Copolymers by Reactive Extrusion,” Prog Polym Sci. 24 (1): 81-142 (1999), which is hereby incorporated by reference in its entirety). According to previous research, the phenoxy radical on the curcumin undergoes a dimerization process that shifts the radical to the ortho or para position relative to the hydroxyl (Curcio et al., “Covalent Insertion of Antioxidant Molecules on Chitosan by a Free Radical Grafting Procedure,” J Agric Food Chem. 57 (13): 5933-8 (2009); Uyama et al., “Peroxidase-Catalyzed Oxidative Polymerization of Bisphenols,” Biomacromolecules 3 (1): 187-93 (2002); Kobayashi S and Higashimura H., “Oxidative Polymerization of Phenols Revisited,” Prog Polym Sci. 28 (6): 1015-48 (2003), which are hereby incorporated by reference in their entirety). The aromatic radical on the curcumin can then react with the PP macroradical to form the grafted product. The proposed mechanism is outlined in FIG. 2.

The temperature profile of the extruder was designed to optimize the grafting reaction. According to TGA and DSC analysis (FIGS. 12 and 13, respectively), curcumin melts at 177° C. and decomposes at 205° C., whereas PP melts at 160° C. and does not decompose until above 400° C. To prevent immediate quenching of the radical initiator by curcumin, a radical scavenger, the first two mixing zones were set to 160° C. and 165° C. to melt only DCP and PP. Therefore, in these initial mixing zones, curcumin was conveyed and mixed with the polymer and initiator in the extruder as a solid powder. Unmelted curcumin can only react on the surface of the solid particles, resulting in minimal reactivity with the DCP radicals. Thus, keeping the initial mixing zones at low temperature allows decomposition of DCP and formation of PP macroradicals while minimizing quenching by curcumin. The final mixing zone was set to 175° C. to melt curcumin, increasing interaction and thus reactivity with the PP and DCP radicals. Temperatures were kept close to the reactant melting temperatures to account for frictional heat (Farahanchi et al., “Effects of Ultrahigh Speed Twin Screw Extrusion on the Thermal and Mechanical Degradation of Polystyrene,” Polymer Engineering & Science 56 (7): 743-51 (2016), which is hereby incorporated by reference in its entirety) and prevent degradation of curcumin due to high temperatures and shear (Esatbeyoglu et al., “Thermal Stability, Antioxidant, and Anti-Inflammatory Activity of Curcumin and its Degradation Product 4-Vinyl Guaiacol,” Food Funct. 6 (3): 887-93 (2015), which is hereby incorporated by reference in its entirety).

Preliminary experiments were performed with 0.1% and 0.5% w/w DCP concentration, and results showed improved immobilization and optical properties of films using 0.5% w/w DCP. Higher concentrations of initiator were not tested based on previous literature demonstrating the degradation of PP mechanical properties as a direct result of increasing DCP concentration (Δzizi et al., “Reactive Extrusion of Polypropylene: Production of Controlled-Rheology Polypropylene (CRPP) by Peroxide-Promoted Degradation,” Polym Test 23 (2): 137-43 (2004), which is hereby incorporated by reference in its entirety). Curcumin concentration of 3% w/w was also tested, but ABTS radical scavenging assay showed no improvement in antioxidant performance over 2% w/w curcumin samples, and discrete particles of curcumin could be seen in the film, indicating saturation. For these reasons, only 1% and 2% w/w curcumin samples were used in subsequent experiments.

Curcumin is an hydrophobic compound with low water solubility (Lee et al., “Curcumin and its Derivatives: Their Application in Neuropharmacology and Neuroscience in the 21st Century,” Curr Neuropharmacol 11 (4): 338-78 (2013), which is hereby incorporated by reference in its entirety), which limits its functional performance in aqueous environments (Silva et al., “Impact of Curcumin Nanoformulation on its Antimicrobial Activity,” Trends in Food Science & Technology 72:74-82 (2018), which is hereby incorporated by reference in its entirety). PP-g-MA has often been used as a hydrophilic compatibilizer in PP blends to improve homogenization by preventing aggregate formation of additives and macromolecules (Li et al., “Mechanical and Dielectric Properties of Graphene Incorporated Polypropylene Nanocomposites Using Polypropylene-Graft-Maleic Anhydride as a Compatibilizer,” Compos Sci Technol. 153:111-8 (2017); Abacha et al., “Synthesis of Polypropylene-Graft-Maleic Anhydride Compatibilizer and Evaluation of Nylon 6/Polypropylene Blend Properties,” Polym Int. 54 (6): 909-16 (2005); Nakason et al., “Rheological Properties of Maleated Natural Rubber/Polypropylene Blends with Phenolic Modified Polypropylene and Polypropylene-g-Maleic Anhydride Compatibilizers,” Polym Test. 25 (3): 413-23 (2006), which are hereby incorporated by reference in their entirety). It was thus hypothesized that the compatibilization of PP-g-MA with PP base polymer would improve interactions between the active polymer and aqueous food matrices, thus expanding the range of foods and beverages with which this active material could perform well. Additionally, PP-g-MA contains both anhydride and carboxylic acid groups, which can interact with the ketone and phenol groups in curcumin to improve miscibility and enhance optical and interfacial properties of the polymer. Thus, studies were performed on both PP-g-Cur films as well as PP-g-Cur/PP-g-MA copolymer films to observe the effects of a compatibilizer on material properties and functionality.

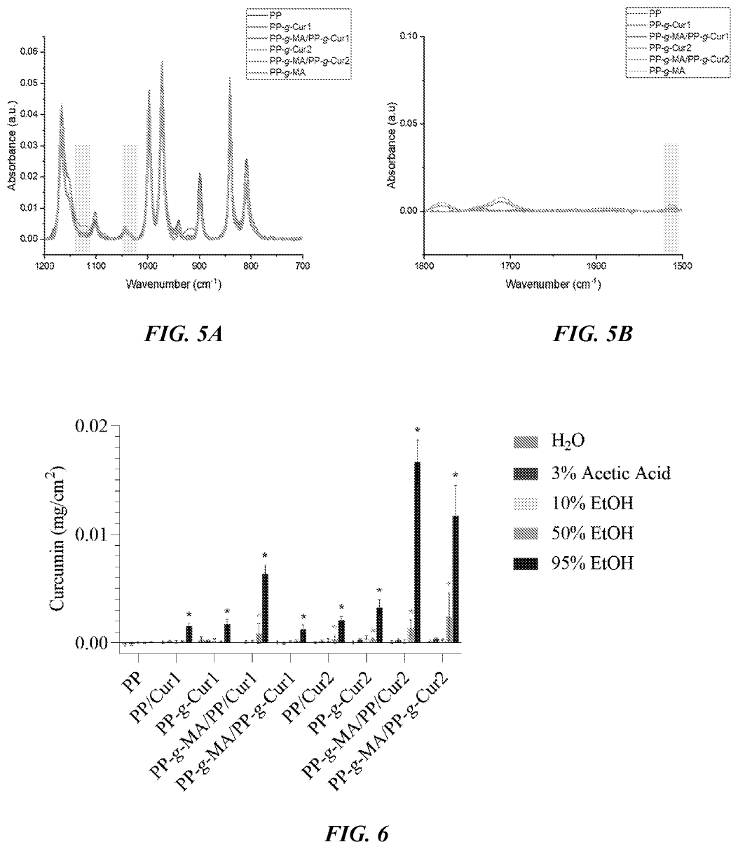

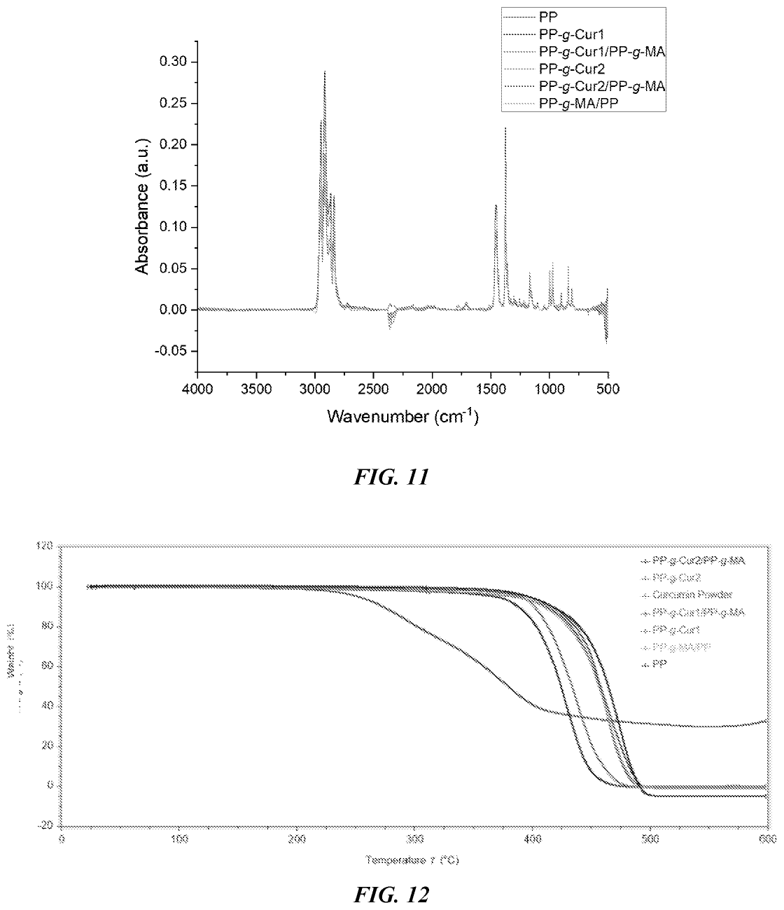

The presence of curcumin in sample films was confirmed by ATR-FTIR (FIGS. 5 and 11). The absorbance band at 1510 cm⁻¹ was attributed to the C═C vibration in curcumin (Darandale et al., “Cyclodextrin-Based Nanosponges of Curcumin: Formulation and Physicochemical Characterization,” Journal of Inclusion Phenomena and Macrocyclic Chemistry 75 (3): 315-22 (2013); de Campos et al., “TPCS/PBAT Blown Extruded Films Added with Curcumin as a Technological Approach for Active Packaging Materials,” Food Packaging and Shelf Life 22:100424 (2019), which are hereby incorporated by reference in their entirety), the band at 1122 cm⁻¹ correlates to the C—O stretching of curcumin on the aromatic ring, and the band at 1035 cm⁻¹ indicates the C—C stretching of curcumin on the aromatic ring (Roy et al., “Carboxymethyl Cellulose-Based Antioxidant and Antimicrobial Active Packaging Film Incorporated with Curcumin and Zinc Oxide,” Int J Biol Macromol. 148:666-76 (2020), which is hereby incorporated by reference in its entirety). These characteristic curcumin absorbance bands are only visible in the PP-g-Cur2 films, likely due to this sample having the highest concentration of curcumin. Other films containing <2% w/w curcumin are likely below the threshold of detection for ATR-FTIR. Spectra of films containing MA have absorbance at 1778 cm⁻¹ and 1710 cm⁻¹, representing carbonyl C═O stretching characteristic of the anhydride and carboxylic acid groups, respectively.

Dynamic water contact angle was performed to characterize the hydrophobicity and interfacial behavior of the treated films (Table 2). Advancing contact angle (θA) was performed by depositing a water droplet on the film surface, expanding the droplet at a constant rate, and recording the maximum contact angle before the baseline of the droplet increases. Receding contact angle (OR) was performed similarly, but by decreasing the water droplet size and recording the contact angle prior to the baseline decreasing. Hysteresis is the difference between advancing and receding contact angle and gives an indication of the chemical heterogeneity of the films surface. All films displayed hydrophobic advancing contact angles (defined as θA ≥90°, with all films here presenting θA>115°), which indicates the desirable low wettability of PP packaging was maintained across all treated samples. Compared to control PP, samples containing curcumin had increased advancing contact angle, likely due to the hydrophobic nature of curcumin. A similar trend was seen by Tsekova et al. when the water contact angle of hydrophobic cellulose acetate (123.10+) 2.0° increased with the addition of curcumin (129.4+) 3.8° (Tsekova et al., “Electrospun Curcumin-Loaded Cellulose Acetate/Polyvinylpyrrolidone Fibrous Materials with Complex Architecture and Antibacterial Activity,” Materials Science and Engineering: C. 73:206-14 (2017), which is hereby incorporated by reference in its entirety). The compatibilization of PP-g-Cur with PP-g-MA further increased the advancing contact angle, likely due to the improved miscibility of the films due to hydrogen bonding interactions between MA carboxylic acids and curcumin. It has been shown in previous studies that improved miscibility can decrease surface free energy, which increases the advancing contact angle of a polymer (Krump et al., “Changes in Free Surface Energy as an Indicator of Polymer Blend Miscibility,” Mater Lett. 59 (4): 517-9 (2005), which is hereby incorporated by reference in its entirety). This result emphasizes the utility of PP-g-MA as a compatibilizer to improve the interfacial properties of the novel material.

TABLE 2
Dynamic water contact angle of treated and control films including
advancing contact angle, receding contact angle, and hysteresis

| | Advancing | Receding | Hysteresis |
|---|---|---|---|
| Sample | (θ_{A}) | (θ_{R}) | (θ) |
| PP | 116.5 ± 2.0^{A} | 94.3 ± 1.9^{A} | 22.1 ± 2.8^{A} |
| PP-g-MA/PP | 120.4 ± 3.9^{AB} | 46.5 ± 4.2^{B} | 73.9 ± 5.5^{B} |
| PP-g-Cur1 | 120.2 ± 8.1^{AB} | 75.4 ± 9.4^{C} | 44.8 ± 3.0^{C} |
| PP-g-MA/PP-g-Cur1 | 126.5 ± 4.9^{BC} | 50.4 ± 3.4^{B} | 76.1 ± 6.4^{B} |
| PP-g-Cur2 | 125.7 ± 2.8^{BC} | 74.8 ± 7.0^{C} | 50.9 ± 5.9^{C} |
| PP-g-MA/PP-g-Cur2 | 130.8 ± 5.3^{C} | 49.5 ± 5.8^{B} | 81.2 ± 6.5^{B} |

Values are the average and standard deviation of two different spots of two different coupons from two independently extruded batches of each sample. Significant differences between means in each column are signified by different uppercase superscript letters (Tukey's HSD, p ≤ 0.05).

Receding contact angles were significantly different between treated and control films. Samples containing MA had the lowest receding contact angles, likely due to the hydrogen bonding of the MA carboxylic acids to water, which increases interaction of the water droplet with the film. PP-g-Cur1 and PP-g-Cur2 exhibited larger receding contact angles than polymers with PP-g-MA, as can be expected due to the hydrophobic nature of PP and curcumin. Since interaction of the active packaging material with aqueous food matrices is important to enable preservative activity, these results once again emphasize the importance of PP-g-MA not only as a compatibilizer within the polymer but also between the polymer and food matrix. Compared to control PP, PP-g-Cur1 and PP-g-Cur2 displayed lower receding contact angles, potentially due to the immiscibility and aggregation of curcumin that increases surface roughness of the films (Zografi et al., “Effects of Surface Roughness on Advancing and Receding Contact Angles,” Int J Pharm. 22 (2): 159-76 (1984), which is hereby incorporated by reference in its entirety). These results reflect desirable surface orientation of the active ligand, which would increase chemical heterogeneity of the sample films, as demonstrated by the increasing hysteresis values. Overall, lower receding contact angles of sample films compared to control PP signifies improved interaction between the functional material and aqueous food matrix, which would support the ability of the active packaging material to impart preservative functionality on packaged foods or beverages.

TGA and DSC were performed to characterize the thermal stability and properties of the treated films (FIGS. 12 and 13, respectively). Although curcumin powder decomposes at much lower temperatures than PP, no additional decomposition steps were observed in any of the samples, likely due to the low concentrations of MA and curcumin compared to PP. PP-g-Cur2 and PP-g-MA/PP-g-Cur2 samples showed slightly lower thermal stability, likely due to the disruption of PP crystallinity by curcumin and MA. DSC spectra showed melting temperatures of 160° C. for control PP, 159° C. for control PP-g-MA/PP, and 157° C. for all sample films. This minor decrease in thermal stability for sample films can be explained by the heterogeneity of the polymer chain with the introduction of MA and curcumin, and by the lower molecular weight of the PP base polymer caused by beta scission during radical grafting (Duvall et al., “Interfacial Effects Produced by Crystallization of Polypropylene with Polypropylene-g-Maleic Anhydride Compatibilitzers,” J Appl Polym Sci. 52 (2): 207-16 (1994), which is hereby incorporated by reference in its entirety). The crystallization temperatures of PP-g-MA/PP, PP-g-MA/PP-g-Cur1, and PP-g-MA/PP-g-Cur2 were 120° C., 118° C., and 118° C., respectively, compared to PP crystallization temperature of 116° C. This increase in crystallization temperature of films containing PP-g-MA can be explained by previous studies that demonstrated how small amounts of MA can act as nucleating agents in PP to facilitate crystallization (Seo et al., “Study of the Crystallization Behaviors of Polypropylene and Maleic Anhydride Grafted Polypropylene,” Polymer. 41 (7): 2639-46 (2000), which is hereby incorporated by reference in its entirety). Despite these minor differences between control and sample films thermal properties, DSC and TGA analysis revealed no practically significant differences for sample films in food packaging applications, and thermoforming and heat-sealing properties were unaffected by the radical grafting of curcumin.

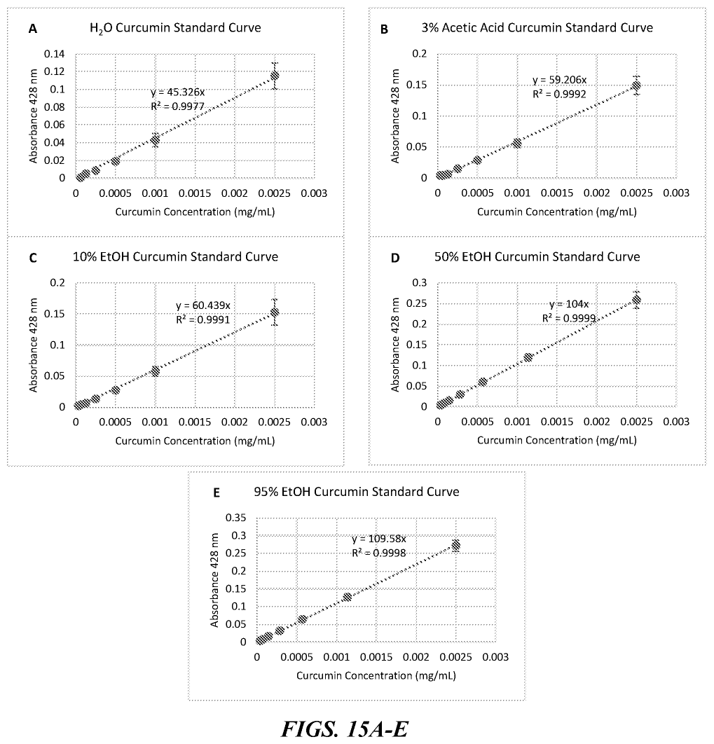

Although curcumin is an approved food additive, the goal of this research was to immobilize curcumin to the polymer surface to impart active preservative and indicating functionality without affecting the quality or formulation of the packaged product. An accelerated migration study was performed based on EU (EU. Commission Regulation (EU) No Oct. 20, 2011 on “Plastic Materials and Articles Intended to Come into Contact with Food,” Official Journal of the European Union. 045:42-130 (2011), which is hereby incorporated by reference in its entirety) and FDA (USFDA, “Guidance for Industry: Preparation of Premarket Submissions for Food Contact Substances (Chemistry Recommendations),” (2018) (available from: https://www.fda.gov/regulatory-information/search-fda-guidance-documents/guidance-industry-preparation-premarket-submissions-food-contact-substances-chemistry #ai), which is hereby incorporated by reference in its entirety) recommendations for food contact materials to quantify the migration of curcumin from PP-g-Cur (FIG. 6). Coupons of control and treated films were incubated in various food simulants for 10 days at 40° C. After incubation, the concentration of curcumin was quantified using curcumin standard curves in each simulant (FIG. 15). Water, 3% acetic acid, 10% ethanol (EtOH), 50% EtOH, and 95% EtOH represent aqueous, acidic, slightly alcoholic or slightly fatty, highly alcoholic, and highly fatty food environments, respectively (USFDA, “Guidance for Industry: Preparation of Premarket Submissions for Food Contact Substances (Chemistry Recommendations)” (2018) (available from: https://www.fda.gov/regulatory-information/search-fda-guidance-documents/guidance-industry-preparation-premarket-submissions-food-contact-substances-chemistry #ai), which is hereby incorporated by reference in its entirety). Regardless of simulant, all sample films exhibited curcumin migration levels significantly below the migratory limit established by the EU for food contact materials (0.1 mg/cm²) (EU. Commission Regulation (EU) No Oct. 20, 2011 on “Plastic Materials and Articles Intended to Come into Contact with Food,” Official Journal of the European Union. 045:42-130 (2011), which is hereby incorporated by reference in its entirety), validating that PP-g-Cur and PP-g-MA/PP-g-Cur films can be used for nonmigratory packaging. Indeed, depending on the simulant, between 0 and 0.0117 mg/cm² migrated, the maximum of which is 8.5 times lower than the EU limit. For water, 3% acetic acid, and 10% EtOH, there was no migration of curcumin across any of the treated films compared to PP. Only films containing both PP-g-MA and Cur2 exhibited statistically significant migration in 50% EtOH, likely due to the hydrogen bonding interactions between the simulant and MA that facilitates better contact with the material. Almost all films showed statistically significant migration in the 95% EtOH simulant, which is expected as EtOH is the best solvent for curcumin extraction (Priyadarsini, “The Chemistry of Curcumin: From Extraction to Therapeutic Agent,” Molecules. 19 (12): 20091-112 (2014), which is hereby incorporated by reference in its entirety). It is worth noting, however, that PP-g-MA/PP-g-Cur1 films exhibited less than a fifth the curcumin migration in 95% EtOH as PP-g-MA/PP/Cur1 films, the only difference being the addition of DCP to radically graft curcumin to PP. This result supports the covalent grafting of curcumin to PP during reactive extrusion. Thus, these materials show great potential as nonmigratory packaging, particularly for aqueous (beverages), acidic (condiments, juices), and slightly lipophilic (meats, seafood, sauces, dressing) products.

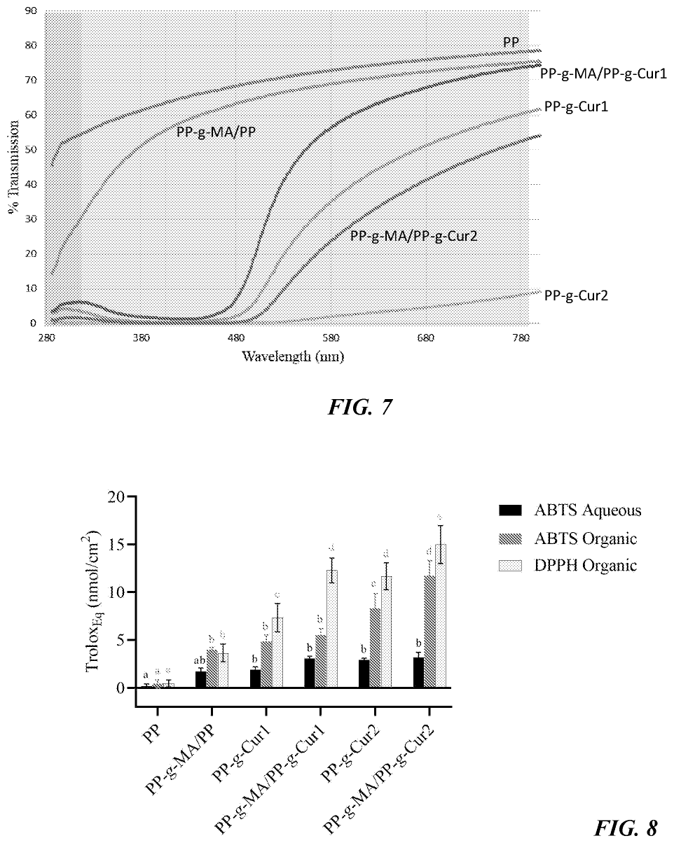

UV-vis spectrophotometry was used to characterize the optical properties of PP-g-Cur films (FIG. 7) based on previous work that demonstrated the UV-blocking capability of curcumin incorporated in migratory carboxymethyl cellulose active packaging (Roy et al., “Carboxymethyl Cellulose-Based Antioxidant and Antimicrobial Active Packaging Film Incorporated with Curcumin and Zinc Oxide,” Int J Biol Macromol. 148:666-76 (2020), which is hereby incorporated by reference in its entirety). UV light exposure can negatively affect components of food that are susceptible to oxidative degradation by free radicals, known as photosensitizers. These components include lipids, colorants, and vitamins and minerals that can significantly impact the appearance, flavor, texture, and nutritional value of the product. Thus, it is of critical importance to reduce the UV degradation of packaged foods (Guzman-Puyol et al., “Transparent, UV-Blocking, and High Barrier Cellulose-Based Bioplastics with Naringin as Active Food Packaging Materials,” Int J Biol Macromol. 209:1985-94 (2022), which is hereby incorporated by reference in its entirety). However, ideal packaging materials would also retain the high visible light transmission of native PP, which allows consumers and manufacturers to see the packaged product. A spectral sweep of treated and control films revealed significant blocking in the UV-B (280-315 nm) and UV-A (315-400 nm) region and high transmission in the visible light region (400-700 nm) (Organization WH. Radiation: Ultraviolet (UV) Radiation (2016) (Δvailable from: https://www.who.int/news-room/questions-and-answers/item/radiation-ultraviolet-(uv) #: ˜: text=The % 20UV %20region % 20covers % 20the (100%2D280%20 nm), which is hereby incorporated by reference in its entirety). For instance, PP-g-MA/PP-g-Cur1 blocked 93% of all UV light while allowing 64% visible light transmission compared to control PP. Blending with PP-g-MA significantly improved visible light transmission compared to films containing no compatibilizer. This difference is likely due to the hydrogen bonding interactions between MA and curcumin that improve miscibility and homogenization, highlighting the importance of a compatibilizer in improving optical properties of the material. Compared to native PP and PP-g-MA, these films have high potential to prevent degradation of packaged products by UV light.

Oxidation of food is due to the formation of reactive oxygen species (ROS) caused by heat, enzymes, transition metals, and/or UV light, which can cause product discoloration, nutrient degradation, and rancidity (Δndré et al., “Analytical Strategies to Evaluate Antioxidants in Food: A Review,” Trends in Food Science & Technology 21 (5): 229-46 (2010), which is hereby incorporated by reference in its entirety). Protection against oxidation is important in both organic and aqueous environments, since ROS can cause lipid oxidation as well as degradation of proteins, vitamins, and sugars (Choe et al., “Chemistry and Reactions of Reactive Oxygen Species in Foods,” J Food Sci. 70 (9): R142-R59 (2005), which is hereby incorporated by reference in its entirety). ABTS and DPPH Trolox equivalent antioxidant capacity (TEAC) assays were used to determine the antioxidant performance of PP-g-Cur films compared to control films, since ABTS assays are typically used for hydrophilic and lypophilic antioxidant systems, and DPPH assays are typically used for hydrophobic antioxidant systems (FIG. 8) (Floegel et al., “Comparison of ABTS/DPPH Assays to Measure Antioxidant Capacity in Popular Antioxidant-Rich US Foods,” Journal of Food Composition and Analysis 24 (7): 1043-8 (2011), which is hereby incorporated by reference in its entirety). The colorimetric decrease of each solution signified sequestering of preformed radicals and was quantified using a standard curve of Trolox, which is the synthetic water-soluble analog to Vitamin E. Across all assays, treated films showed significant antioxidant capacity compared to control PP, which had negligible TEAC values. PP-g-MA/PP-g-Cur2, displayed the highest TEAC values across all assays, with 3.18, 11.71, and 14.98 Trolox_{Eq} (nmol/cm²) for aqueous ABTS, organic ABTS, and organic DPPH, respectively. The aqueous ABTS assay displayed the lowest TEAC values for PP-g-Cur films, potentially due to the limited interaction between the hydrophobic material and aqueous environment. However, aqueous ABTS values are higher than those reported by other nonmigratory antioxidant active packaging studies with demonstrated efficacy in preventing oxidative degradation, such as PLA grafted with nitrilotriacetic acid (0.89±0.07 Trolox_{Eq} (nmol/cm²)) (Herskovitz et al., “Antioxidant Functionalization of Biomaterials via Reactive Extrusion,” J Appl Polym Sci. 138 (25): 50591 (2021), which is hereby incorporated by reference in its entirety) and polyethylene grafted with fish peptide (˜1.2 Trolox_{Eq} (nmol/cm²)) (Romani et al., “Radical Scavenging Polyethylene Films as Antioxidant Active Packaging Materials,” Food Control 109:106946 (2020), which is hereby incorporated by reference in its entirety). The ABTS and DPPH assays performed in organic solvent showed significantly higher TEAC values across all treated films, likely due to the improved interactions between curcumin and EtOH as seen in the migration assay for 95% EtOH simulant. As EtOH is the preferred solvent for curcumin extraction, it can be assumed that EtOH would have significant hydrogen bonding interactions with the grafted curcumin, improving interactions between the antioxidant films and free radicals in solution. In the organic ABTS assay, PP-g-Cur2 and PP-g-MA/PP-g-Cur2 films were the only samples with significant TEAC values compared to the control PP-g-MA/PP, likely due to the higher concentration of curcumin in PP-g-Cur2 and the increased polarity in PP-g-MA/PP-g-Cur2. DPPH showed slightly different results, with all samples performing between 2-4 times better than the PP-g-MA/PP control. In addition, this assay showed a synergistic effect between PP-g-Cur and PP-g-MA, where the TEAC value of PP-g-MA/PP-g-Cur films was higher than either of the polymers individually. For instance, TEAC values for PP-g-MA/PP and PP-g-Cur2 were 3.65 and 11.67 Trolox_{Eq} (nmol/cm²), respectively. PP-g-MA/PP-g-Cur2, which contains the same concentration of PP-g-MA as PP-g-MA/PP films and only half the concentration of curcumin as PP-g-Cur2 films, would have an expected TEAC value of ˜9.49 Trolox_{Eq} (nmol/cm²). However, the experimental TEAC value of PP-g-MA/PP-g-Cur2 was 14.98 Trolox_{Eq} (nmol/cm²), which shows a synergistic effect between PP-g-MA and curcumin. One explanation of this effect could be the hydrogen bonding interactions between MA and curcumin, which could help to stabilize curcumin's anionic form. According to Litwinienko et al., curcumin scavenges DPPH radicals by sequential proton loss electron transfer (SPLET), in which the keto-enol moiety of curcumin becomes deprotonated in an ionizing solvent (EtOH), forming an anion that then transfers an electron to DPPH radicals (Litwinienko et al., “Abnormal Solvent Effects on Hydrogen Atom Abstraction. 2. Resolution of the Curcumin Antioxidant Controversy. The Role of Sequential Proton Loss Electron Transfer,” J Org Chem. 69 (18): 5888-96 (2004), which is hereby incorporated by reference in its entirety). Hydrogen bonding between curcumin and MA may accelerate the ionization of curcumin by stabilizing the anionic form, which would improve DPPH radical scavenging in organic conditions as observed here.

Treated and control films were tested in aqueous ABTS, organic ABTS, and organic DPPH assays to demonstrate the antioxidant properties and performance of PP-g-Cur films in different environments. The ABTS assay is often utilized to demonstrate antioxidant performance in lipophilic and hydrophilic systems, whereas the DPPH assay is standard for hydrophobic antioxidants such as polyphenols (Floegel et al., “Comparison of ABTS/DPPH Assays to Measure Antioxidant Capacity in Popular Antioxidant-Rich US Foods,” Journal of Food Composition and Analysis 24 (7): 1043-8 (2011), which is hereby incorporated by reference in its entirety). All assays displayed significant radical scavenging capacity of treated films, highlighting the applicability of PP-g-Cur as antioxidant packaging for both lipophilic and aqueous food systems. According to previous studies, curcumin scavenges both ABTS and DPPH radicals primarily by the SPLET mechanism (Litwinienko et al., “Abnormal Solvent Effects on Hydrogen Atom Abstraction. 2. Resolution of the Curcumin Antioxidant Controversy. The Role of Sequential Proton Loss Electron Transfer,” J Org Chem. 69 (18): 5888-96 (2004); Shaikh et al., “Unravelling the Effect of B-Diketo Group Modification on the Antioxidant Mechanism of Curcumin Derivatives: A Combined Experimental and DFT Approach,” J Mol Struct. 1193:166-76 (2019), which are hereby incorporated by reference in their entirety). Since this mechanism is dependent on the deprotonation of curcumin, the solvent plays a major role in the kinetics of curcumin radical scavenging. EtOH is an ionizing solvent that facilitates deprotonation of curcumin's enol moiety, which allows the SPLET mechanism to dominate the organic ABTS and DPPH assays (Litwinienko et al., “Abnormal Solvent Effects on Hydrogen Atom Abstraction. 2. Resolution of the Curcumin Antioxidant Controversy. The Role of Sequential Proton Loss Electron Transfer,” J Org Chem. 69 (18): 5888-96 (2004); Shaikh et al., “Unravelling the Effect β-Diketo Group Modification on the Antioxidant Mechanism of Curcumin Derivatives: A Combined Experimental and DFT Approach,” J Mol Struct. 1193:166-76 (2019), which are hereby incorporated by reference in their entirety). On the other hand, the aqueous assay is performed at pH 7.4, which is below the pKₐ of the enolic hydrogen (pH 7.8) (Zebib et al., “Stabilization of Curcumin by Complexation with Divalent Cations in Glycerol/Water System,” Bioinorg Chem Appl. 2010:292760 (2010), which is hereby incorporated by reference in its entirety). Since curcumin is not deprotonated at this pH value it is believed that the primary mechanism of aqueous ABTS radical scavenging is by hydrogen atom transfer (HAT) from curcumin's phenol moiety, which is significantly slower than the SPLET mechanism. As a result, it is possible a longer incubation time in the aqueous ABTS assay would yield higher radical scavenging results for curcumin, however, the instability of the ABTS radical at pH 7.4 limits the incubation time of this assay. Overall, these assays help to elucidate the mechanisms that dominate curcumin's radical scavenging performance in various environments.

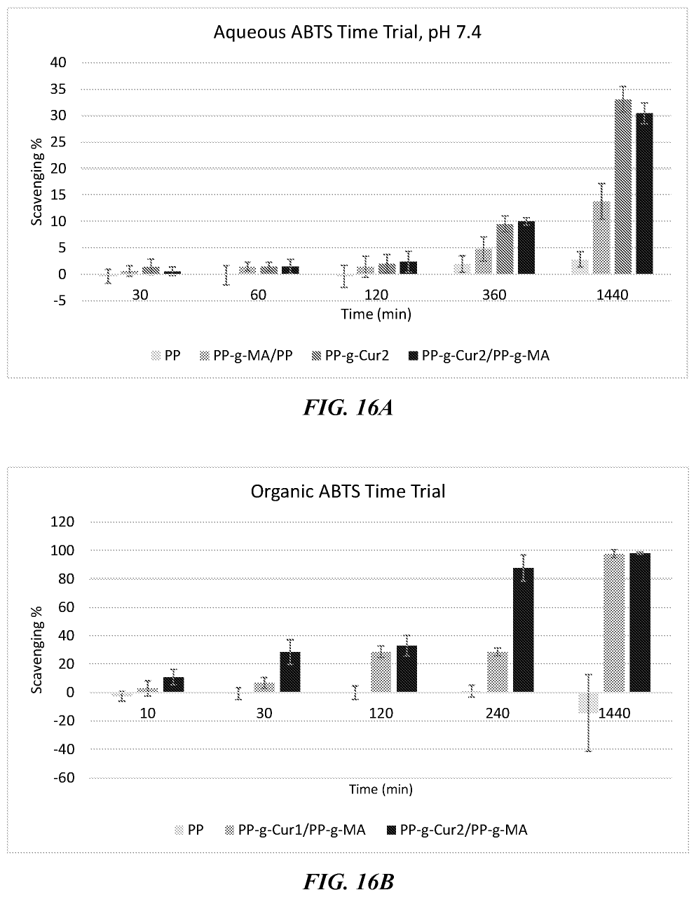

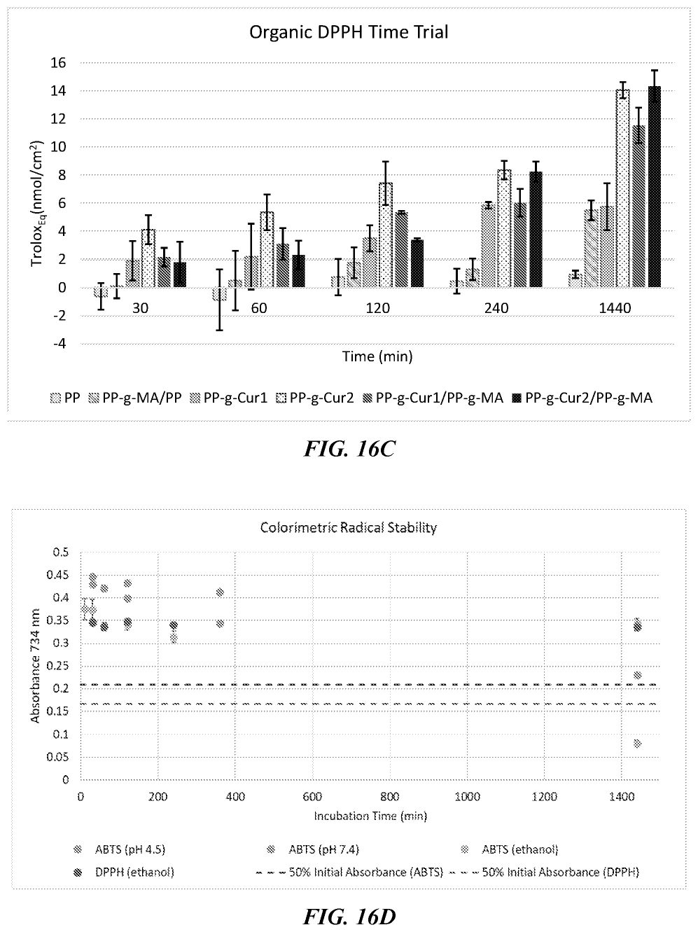

Since previous research has highlighted the time-dependence of radical scavenging assays, preliminary experiments were conducted to determine the optimal incubation time for measuring antioxidant performance of treated films (FIGS. 16A-D). Previous studies have shown that traditional incubation times (between 5-30 minutes) underestimate the TEAC values of polyphenols due to the slow radical scavenging mechanisms (Ozgen et al., “Modified 2,2-Azino-bis-3-Ethylbenzothiazoline-6-Sulfonic Acid (ΔBTS) Method to Measure Antioxidant Capacity of Selected Small Fruits and Comparison to Ferric Reducing Antioxidant Power (FRAP) and 2,2′-Diphenyl-1-picrylhydrazyl (DPPH) Methods,” J Agric Food Chem. 54 (4): 1151-7 (2006); Pérez-Jiménez et al., “Anti-Oxidant Capacity of Dietary Polyphenols Determined by ABTS Assay: A Kinetic Expression of the Results,” International Journal of Food Science & Technology 43 (1): 185-91 (2008); Walker et al., “Comparative Reaction Rates of Various Antioxidants with ABTS Radical Cation,” J Agric Food Chem. 57 (4): 1156-61 (2009), which are hereby incorporated by reference in their entirety). The incubation time chosen for each assay was based on the highest TEAC value for PP-g-Cur films while the control radical solution (containing no film) maintained greater than 50% its initial absorbance value. ABTS and DPPH radicals are unstable, and the color of the solutions tends to degrade over time without radical scavenging by antioxidants. This instability is particularly true for ABTS solutions in EtOH or neutral/basic buffered aqueous systems, which are significantly less stable than acidic ABTS solutions (FIGS. 16A-D). The ABTS and DPPH solutions were incubated without films throughout the time trial experiment to monitor when absorbance fell below 50% of the initial value, a level used by previous studies to indicate radical instability (Ozgen et al., “Modified 2,2-Azino-bis-3-Ethylbenzothiazoline-6-Sulfonic Acid (ΔBTS) Method to Measure Antioxidant Capacity of Selected Small Fruits and Comparison to Ferric Reducing Antioxidant Power (FRAP) and 2,2′-Diphenyl-1-picrylhydrazyl (DPPH) Methods,” J Agric Food Chem. 54 (4): 1151-7 (2006); Cano et al., “An End-Point Method for Estimation of the Total Antioxidant Activity in Plant Material,” Phytochem Anal. 9 (4): 196-202 (1998); which are hereby incorporated by reference in their entirety). This restriction ensured that the observed decrease in absorbance was due to radical scavenging rather than radical instability. Results demonstrated radical scavenging performance of PP-g-Cur films increased significantly over time, which is relevent for food packaging applications which seek to improve shelf-life over the course of days, weeks, or months. Without these preliminary experiments, traditional incubation times for ABTS and DPPH assays would have significantly underestimated the antioxidant capacity of treated films. This time trial data highlights the importance of understanding radical scavenging kinetics of different compounds to fully demonstrate their antioxidant performance.

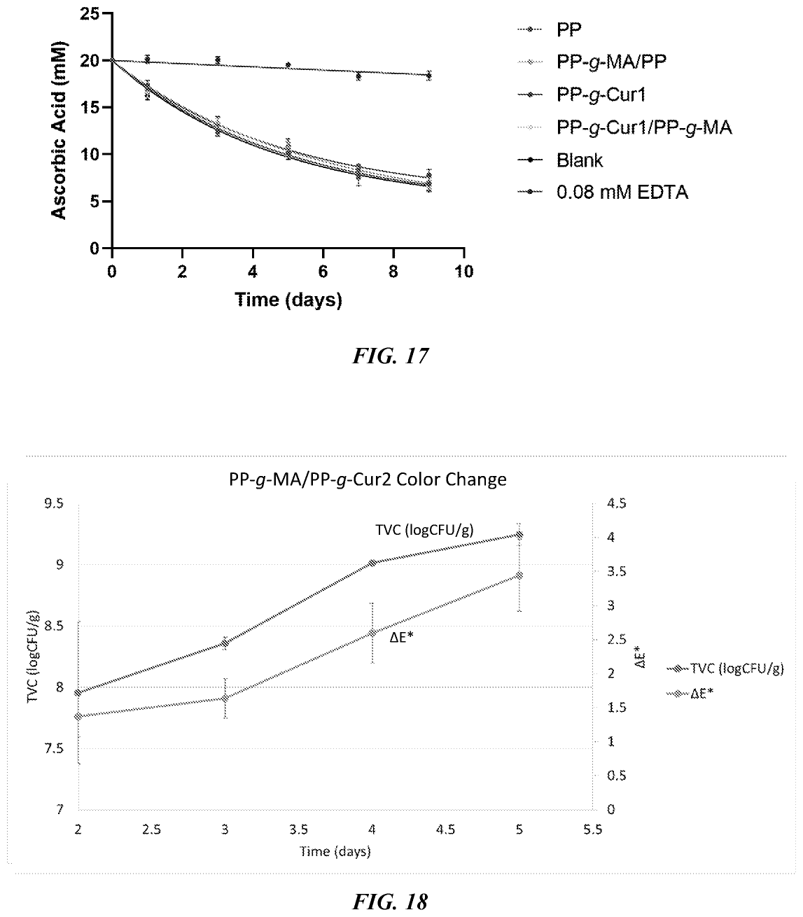

An accelerated ascorbic acid degradation study was performed to demonstrate whether treated films provided protection against metal-catalyzed oxidation (FIG. 17). Trace metals found in food and beverages such as copper and iron can accelerate oxidation and nuritent degradation (Akbιyιk et al., “Protection of Ascorbic Acid from Copper (II)—Catalyzed Oxidative Degradation in the Presence of Fruit Acids: Citric, Oxalic, Tartaric, Malic, Malonic, and Fumaric Acids,” International Journal of Food Properties 15 (2): 398-411 (2012), which is hereby incorporated by reference in its entirety), which can be inhibited by the presence of metal chelators. Previous studies have demonstrated the chelating performance of curcumin for therapeutic applications (Mary et al., “Metal Chelating Ability and Antioxidant Properties of Curcumin-Metal Complexes-A DFT Approach,” J Mol Graphics Modell. 79:1-14 (2018); Borsari et al., “Curcuminoids as Potential New Iron-Chelating Agents: Spectroscopic, Polarographic and Potentiometric Study on their Fe (III) Complexing Ability,” Inorg Chim Acta. 328 (1): 61-8 (2002), which are hereby incorporated by reference in their entirety), which primarily occur at physiological pH values. However, most food systems are acidic, particularly those that use ascorbic acid such as fruit, beverages, and condiments. In this assay, which was performed at pH 4.0 to represent typical food applications, treated films showed no protection against ascorbic acid degradation compared to control PP. Under neutral and acidic conditions the bis-keto form of curcumin is dominant, whereas under basic conditions the keto-enol form is dominant (García-Niño et al., “Protective Effect of Curcumin Against Heavy Metals-Induced Liver Damage,” Food Chem Toxicol. 69:182-201 (2014), which is hereby incorporated by reference in its entirety). Since the metal chelating properties of curcumin are dependent on the anionic keto-enol complex, curcumin likely cannot chelate metals in acidic food applications, as demonstrated by these results.

Radical scavenging and ascorbic acid degradation results demonstrate the importance of interfacial properties in predicting and tailoring functional performance of active materials to speicific applications. These experiments add to the growing body of knowledge concerning the mechnistic performance of natural active agents like curcumin. Importantly, while the films weren't effective in preventing ascorbic acid degradation, significant radical scavenging capacity demonstrates their efficacy as nonmigratory antioxidant materials.

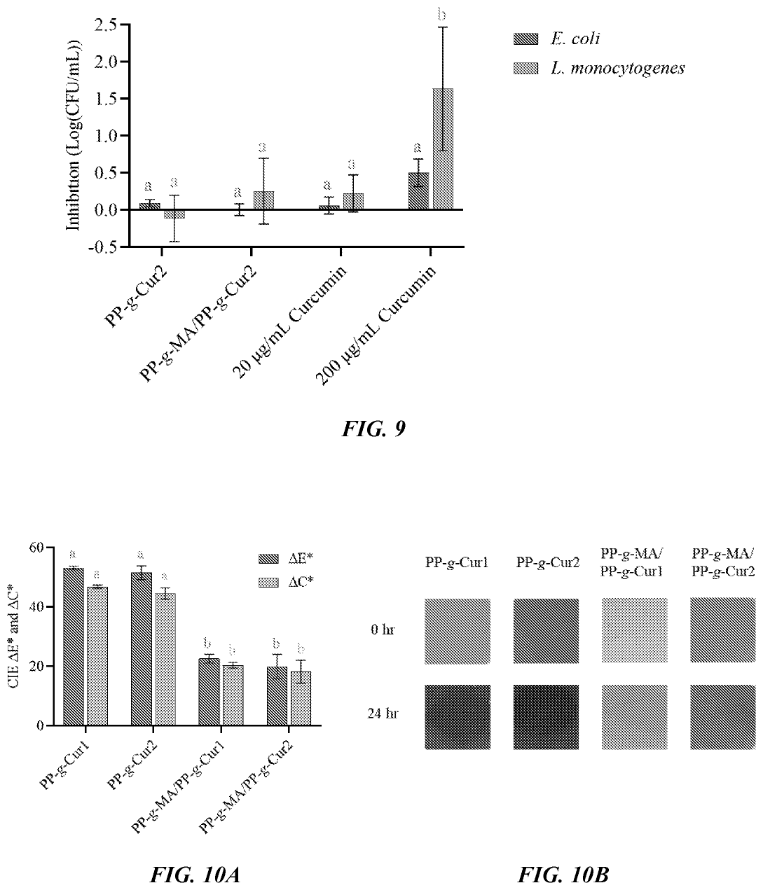

It is estimated that one-fourth of global food waste can be attributed to microbial spoilage (Zwirzitz et al., “The Sources and Transmission Routes of Microbial Populations Throughout a Meat Processing Facility,” NPJ Biofilms Microbiomes 6 (1): 26 (2020), which is hereby incorporated by reference in its entirety), which can cause off-odors, undesirable flavors, visible slimes and molds, and textural degradation that leads to consumer rejection and food waste (Gram et al., “Food Spoilage-Interactions Between Food Spoilage Bacteria,” International Journal of Food Microbiology 78 (1): 79-97 (2002), which is hereby incorporated by reference in its entirety). Previous work on curcumin migratory packaging has shown strong antibacterial efficacy against both Gram-negative and Gram-positive strains (Roy et al., “Carboxymethyl Cellulose-Based Antioxidant and Antimicrobial Active Packaging Film Incorporated with Curcumin and Zinc Oxide,” Int J Biol Macromol. 148:666-76 (2020); de Campos et al., “TPCS/PBAT Blown Extruded Films Added with Curcumin as a Technological Approach for Active Packaging Materials,” Food Packaging and Shelf Life 22:100424 (2019); Roy et al., “Preparation of Antimicrobial and Antioxidant Gelatin/Curcumin Composite Films for Active Food Packaging Application,” Colloids and Surfaces B:Biointerfaces 188:110761 (2020), which are hereby incorporated by reference in their entirety), so treated films were tested against common food-borne pathogens E. coli and L. monocytogenes (FIG. 9). Since treated films are nonmigratory, the Japanese Industrial Standard (JIS) Z2801: 2000 method was used to ensure constant contact between the bacterial solution and films (Association JS., “Antimicrobial products:Test for Antimicrobial Activity and Efficacy,” Japanese Industrial Standard JIS Z 2801 (2000), which is hereby incorporated by reference in its entirety), and only PP-g-Cur2 and PP-g-MA/PP-g-Cur2 films were used as they contain the highest concentration of curcumin. Previous studies reported the minimum inhibitory concentration (MIC) of curcumin to be between 100-200 μg/mL against E. coli (Gunes et al., “Antibacterial Effects of Curcumin: An in Vitro Minimum Inhibitory Concentration Study,” Toxicology and Industrial Health 32 (2): 246-50 (2016); Almeida et al., “Bioactive Evaluation and Application of Different Formulations of the Natural Colorant Curcumin (E100) in a Hydrophilic Matrix (Yogurt),” Food Chem. 261:224-32 (2018), which are hereby incorporated by reference in their entirety), so 20 μg/mL and 200 μg/mL were chosen to represent curcumin concentrations below and above the reported MIC. None of the samples (aside from 200 μg/mL curcumin against L. monocytogenes) displayed any antibacterial efficacy compared to the control. It is believed that the lack of antibacterial performance of PP-g-Cur2 films could be due to the limited interaction between the aqueous bacterial suspension and hydrophobic polymer. It was expected that copolymerization with PP-g-MA would improve active performance in aqueous matrices, but the PP-g-MA/PP-g-Cur2 film may not contain enough surface-oriented curcumin to be effective.

Antimicrobial activity of solutions of free curcumin were tested to determine whether the lack of antibacterial performance was due to the limitations of free curcumin or due to limitations of the treated films such as lack of surface orientation, insufficient curcumin concentration, polymer hydrophobicity, or steric hindrance due to grafting. The 20 μg/mL curcumin was fully solubilized in the bacterial suspension but did not display any antibacterial function, as expected since this concentration is significantly below the reported MIC. The 200 μg/mL solution of curcumin partially fell out of solution upon dilution in TSB but showed some efficacy against L. monocytogenes (1.63±0.83 log (CFU/mL) inhibition), though not a practically significant effect to be relevant for food applications. Thus, even the maximum concentration of free curcumin that could be solubilized in the bacterial suspension demonstrated minimal antibacterial performance. These results highlight the challenge of using curcumin as an antimicrobial agent due to its extreme hydrophobicity and poor solubility, which is why recent efforts have focused on developing water-soluble curcumin (Yadav et al., “Making of Water Soluble Curcumin to Potentiate Conventional Antimicrobials by Inducing Apoptosis-Like Phenomena Among Drug-Resistant Bacteria,” Scientific Reports 10 (1): 14204 (2020), which is hereby incorporated by reference in its entirety), encapsulated curcumin (Gómez-Estaca et al., “Improving Antioxidant and Antimicrobial Properties of Curcumin by Means of Encapsulation in Gelatin Through Electrohydrodynamic Atomization,” Food Hydrocolloids 70:313-20 (2017); Trigo Gutierrez et al., “Encapsulation of Curcumin in Polymeric Nanoparticles for Antimicrobial Photodynamic Therapy,” PLOS ONE 12 (11): e0187418 (2017), which are hereby incorporated by reference in their entirety), and curcumin nanoparticles (Bhawana et al., “Curcumin Nanoparticles: Preparation, Characterization, and Antimicrobial Study,” J Agric Food Chem 59 (5): 2056-61 (2011); Song et al., “Synergistic Antibacterial Effects of Curcumin Modified Silver Nanoparticles Through ROS-Mediated Pathways,” Materials Science and Engineering: C 99:255-63 (2019), which are hereby incorporated by reference in their entirety) for antimicrobial applications. Overall, while it may be possible to slightly improve the antibacterial properties of films through higher concentrations of grafted curcumin or further hydrophilic modification, the hydrophobic properties of curcumin would likely limit any significant or practical antimicrobial behavior.

Microbial spoilage of meat and seafood results in the release total volatile basic nitrogen (TVBN) compounds that increase the alkalinity of the product. The phenolic hydroxyl groups of curcumin can become deprotonated upon exposure to alkaline conditions such as those produced by meat and seafood, changing the color of curcumin from yellow to red. Thus, curcumin has been explored for use as a spoilage indicator for packaged meat and seafood through visible color change (Liu et al., “Films Based on K-Carrageenan Incorporated with Curcumin for Freshness Monitoring,” Food Hydrocolloids 83:134-42 (2018), which is hereby incorporated by reference in its entirety). Previous work involving curcumin intelligent packaging has demonstrated success using ammonia to replicate the release of TVBN by bacteria (Zhai et al., “Extruded Low Density Polyethylene-Curcumin Film: A Hydrophobic Ammonia Sensor for Intelligent Food Packaging,” Food Packaging and Shelf Life 26:100595 (2020); Yildiz et al., “Monitoring Freshness of Chicken Breast by Using Natural Halochromic Curcumin Loaded Chitosan/PEO Nanofibers as an Intelligent Package,” Int J Biol Macromol. 170:437-46 (2021); Ma et al., “Tara Gum/Polyvinyl Alcohol-Based Colorimetric NH3 Indicator Films Incorporating Curcumin for Intelligent Packaging,” Sensors and Actuators B: Chemical. 244:759-66 (2017), which are hereby incorporated by reference in their entirety). To test the color changing properties of PP-g-Cur films, sample coupons were exposed to ammonia for 24 hours and analyzed using a colorimeter (FIG. 10). To correlate color change values to visual observation, photographs of samples were taken before and after incubation. The ΔE* values observed for all treated films were similar to values observed by Cvek et al. when curcumin-blended polylactic acid/poly (propylene carbonate) packaging was exposed to ammonia. This group also demonstrated the ability of the material to detect shrimp spoilage for intelligent packaging applications (Cvek et al., “Biodegradable Films of PLA/PPC and Curcumin as Packaging Materials and Smart Indicators of Food Spoilage,” ACS Applied Materials & Interfaces 14 (12): 14654-67 (2022), which is hereby incorporated by reference in its entirety), indicating the PP-g-Cur films reported here may be capable of these applications as well. The ΔC* values for PP-g-Cur films were reported to emphasize that the primary color change of all films was from yellow to red. Photographs demonstrate the visible color change of the films, which is important as a qualitative visual indicator to customers and manufacturers of food spoilage. Films containing PP-g-MA showed a decrease in color change compared to films without PP-g-MA, possibly due to the interaction of PP-g-MA with ammonia. The carboxylic acids present in PP-g-MA have a lower pKₐ than that reported for the phenolic hydroxyls in curcumin, which could result in partial quenching of the ammonia (Redfearn et al., “Antioxidant and Dissociation Behavior of Polypropylene-Graft-Maleic Anhydride,” J Appl Polym Sci. 139 (32): e52764 (2022); Zebib et al., “Stabilization of Curcumin by Complexation with Divalent Cations in Glycerol/Water System,” Bioinorg Chem Appl. 2010:292760 (2010), which are hereby incorporated by reference in their entirety). In addition to demonstrating the application of this material as intelligent packaging, these results support that curcumin was not degraded during extrusion, since possible degradation products such as ferulic acid and 4-vinyl guaiacol are incapable of this color change (Esatbeyoglu et al., “Thermal Stability, Antioxidant, and Anti-Inflammatory Activity of Curcumin and its Degradation Product 4-Vinyl Guaiacol,” Food Funct. 6 (3): 887-93 (2015), which is hereby incorporated by reference in its entirety).

### Example 4-Evaluation of PP-g-Cur Films to Indicate Spoilage

A package of shrimp was prepared using PP-g-Cur film. FIG. 18 shows application of color changing PP-g-Cur films to indicate spoilage of shrimp. During spoilage, microorganisms release of volatile basic nitrogen compounds, which react with curcumin and change the color of PP-g-Cur films from yellow to red. Total viable count (TVC) of the shrimp increases with the total color change (ΔE*) of the films during storage of shrimp at 4° C., demonstrating the ability of PP-g-Cur films to indicate microbial spoilage in real food applications. Values are the average and standard deviation of three replicates for each time point.

### Example 5-Synthesis of PLA-Graft-Curcumin (PLA-g-Cur)

Curcumin (cat no. 8.20354, CAS no. 458-37-7) was purchased from Millipore Sigma (Burlington, MA). Dicumyl peroxide (DCP) was purchased from Krackeler Scientific (Δlbany, NY) and homogenized into a fine powder using a mortar and pestle. Ethanol (200 proof) was procured from Decon Labs (King of Prussia, PA). Polylactic acid (PLA) pellets (Ingeo™ Biopolymer 7001D) were obtained from NatureWorks LLC (Minnetonka, MN, USA). Grades U, E, and EX purge for the extruder were generously donated by Asahi Kasei Asaclean Americas (Parsippany, NJ, USA). All reagents were used as received without further purification.

To facilitate homogenous mixtures of polymer pellets and reagent powders, PLA pellets were first extruded and granulated to a smaller pellet size. Briefly, PLA pellets were dried at 80° C. for 4 hours then fed into a Process 11 Parallel Twin Screw Extruder (Thermo Fisher Scientific, Waltham, MA, USA) through an attached volumetric feeder (11 mm volumetric single screw feeder for process 11 [MK2] by Thermo Electron, Germany) at 10% the maximum rate. The pellets were extruded at 150 rpm through a 1.5 mm die using the following temperature profile: Zone 2—145° C., Zone 3—190° C., Zone 4—200° C., Zone 5—200° C., Zone 6—200° C., Zone 7—200° C., Zone 8—200° C., and 210° C. at the die. The extruded polymer strands were fed into a Vericut Pelletizer (ThermoFisher Scientific, Waltham, ME) using the L1 setting to cut 0.5 mm granules of PLA (gPLA). Granules were stored over anhydrous calcium sulfate desiccant for at least 24 hours prior to pressing. To obtain polymer films, 2 g of gPLA were placed in a single layer between two 5 mil Kapton films (Cole-Parmer, Vernon Hills, IL) and allowed to melt in a heated four post manual hydraulic press (Carver, Wabash, IN) at 180° C. for 2 minutes. Films were then pressed for 5 minutes to a thickness of 0.16±0.03 mm and stored over calcium sulfate desiccant for at least 24 hours prior to processing and analysis. Films were immersed in absolute ethanol and shaken at 150 rpm for 2 hours to wash any contaminants. The films were dried with a filtered compressed air gun and stored over anhydrous calcium sulfate desiccant until further use.

Granulated PLA (gPLA, see above), dicumyl peroxide (DCP), and curcumin were used to synthesize active and intelligent PLA-g-Cur via radical grafting in the melt by reactive extrusion as illustrated in FIG. 4. DCP was received as large pellets, which were homogenized into a fine powder using a mortar and pestle and stored at 4° C. until further use. gPLA was mechanically mixed with 0.5% w/w powdered DCP and either 1% or 2% w/w curcumin and fed into a Process 11 Parallel Twin Screw Extruder (Thermo Fisher Scientific, Waltham, MA, USA) through an attached volumetric feeder (11 mm volumetric single screw feeder for process 11 [MK2] by Thermo Electron, Germany) at 18% the maximum rate. Mixtures containing 1% and 2% w/w curcumin and gPLA without DCP were also extruded as controls for the radical grafting reaction. The mixtures were extruded at 150 rpm through a 1.5 mm die using the following temperature profile: Zone 2—145° C., Zone 3—160° C., Zone 4—165° C., Zone 5—170° C., Zone 6—180° C., Zone 7—185° C., Zone 8—195° C., and 210° C. at the die. The mixing elements of the extruder screws were placed in Zones 3, 4, and 6, with the rest of the zones containing screw conveying elements. Extruded samples were pelletized, pressed, washed, and stored using the same parameters as described for gPLA. Nomenclature for these samples is as follows: PLA-g-CurX for samples processed with DCP and PLA/CurX for samples processed without DCP, in which X refers to the weight percentage of curcumin and slashes indicate unreacted (melt blended without radical grafting) blends.

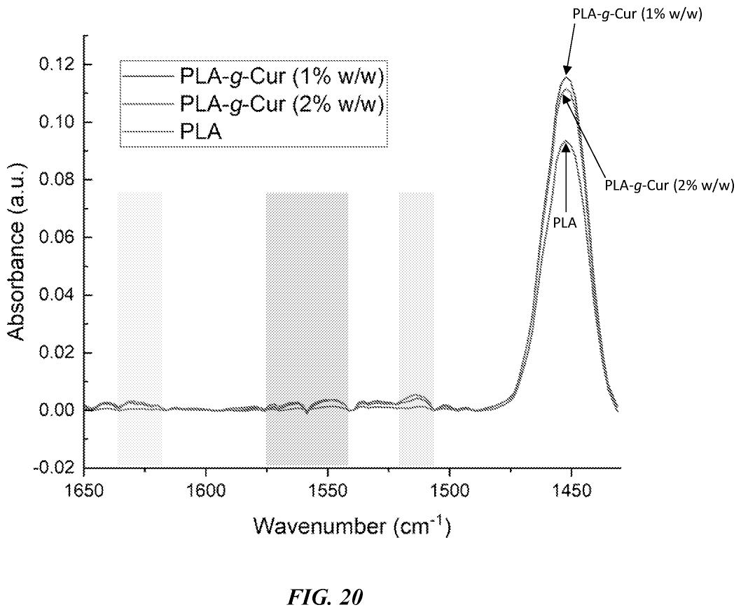

The presence of curcumin in sample films was confirmed by ATR-FTIR (FIG. 20). ATR-FTIR using an IRPrestige FTIR spectrometer equipped with a diamond ATR crystal (Shimadzu Scientific Instruments Inc., Kyoto, Japan) was used to identify characteristic functional groups of each sample. Spectra were taken from the average of 32 scans using Happ-Genzel apodization and 4 cm⁻¹ resolution with air as the background spectrum. FTIR spectra of PLA-g-Cur films containing 1% and 2% w/w curcumin were compared to a control PLA. Sample films demonstrate absorbance bands at 1629 cm−1, 1575-1540 cm⁻¹, and 1515 cm⁻¹, characteristic of curcumin carbonyl C—O stretching, aromatic C—C═C stretching, and ethylene C═C stretching, respectively, indicating the presence of curcumin in PLA-g-Cur films post-ethanol wash.

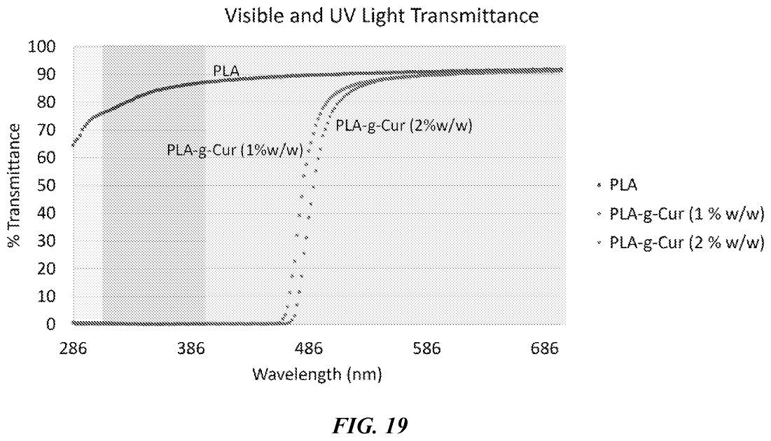

UV-vis spectrophotometry was used to characterize the optical properties of PLA-g-Cur films (FIG. 19). UV-vis spectrophotometry of PLA-g-Cur films containing 1% and 2% w/w curcumin was compared to control PLA. UV-B (280-315 nm), UV-A (315-400 nm), and visible (400-700 nm) light spectra are indicated by yellow, red, and blue highlighting (in color figure), respectively. Treated films demonstrated nearly complete blocking of all UV wavelengths while allowing visible light transmission comparable to control PLA, particularly at the wavelength indicative of material transparency (600 nm). UV-vis properties exhibit the ability of PLA-g-Cur films to maintain desirable product visibility while inhibiting UV degradation of packaged goods. Absorbance measurements were taken every 2 nm for three replicates of each sample. Points shown are the average of all replicates for each sample.

### CONCLUSION

In the preceding examples, reactive extrusion—a scalable, efficient, and continuous process—was used to develop nonmigratory active and intelligent packaging to reduce food waste. The thermal stability and hydrophobicity of native PP was retained in treated films, and the maximum curcumin migration from PP-g-Cur material was confirmed to be less than one-fifth the EU migratory limit. Treated films maintained 64% transparency while blocking 93% of UV light, which could prevent photodegradation of packaged goods while retaining product visibility. Ascorbic acid degradation and radical scavenging assays demonstrated that the antioxidant behavior of these films is due to radical scavenging rather than metal chelating functionality. Results from ABTS and DPPH assays and time trials supported the SPLET antioxidant mechanism of curcumin in ionizing solvent (EtOH) and the HAT antioxidant mechanism of curcumin in non-ionizing solvent (aqueous, pH 7.4). These results also highlighted the significance of radical scavenging kinetics in analyzing different compounds, particularly polyphenols and other natural antioxidants whose slow scavenging mechanisms may result in significant underestimation of performance under short incubation times. PP-g-Cur films were tested against both Gram-positive and Gram-negative bacteria but revealed no antibacterial functionality compared to control PP. Antibacterial analysis of free curcumin highlighted the challenges of using curcumin in aqueous applications due to its extremely low solubility and high hydrophobicity, which could limit bacterial inhibition by PP-g-Cur films. Finally, exposure to ammonia gas changed the color of treated films both visually and quantitatively, demonstrating the ability of these films to act as intelligent packaging to indicate spoilage of meat and seafood products.

Results of the preceding Examples demonstrate, for the first time, immobilization of a multifunctional preservative and indicating compound (curcumin) through a single-step, solvent-free process, which can be adapted to a range of other thermoplastic polymers and polyphenolic compounds with applications beyond food. Indeed, this is exemplified by the preparation of PLA-g-Cur, which will be similarly evaluated. This work presents not only a nonmigratory packaging material to reduce food loss and waste, but also a method to advance the capabilities and commercial viability of functional materials. Furthermore, results from this project emphasize the importance of systematic applications-driven method development, such as in antioxidant or antibacterial assays, to highlight the true capacity and limitations of materials in real application environments.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

1. A method of making an active and/or intelligent packaging material, the method comprising:
providing a polymeric material comprising a tertiary carbon or hydroxyl group;
reacting the polymeric material with a radical scavenging ligand and a radical initiator in an extruder under distinct first and second reaction conditions to cause covalent binding of the radical scavenging ligand to the polymeric material by direct bond formation; and
extruding the active and/or intelligent packaging material.

2. The method according to claim 1, wherein the polymeric material is selected from the group consisting of polylactic acid, polypropylene, polybutylene, polyhydroxy butyrate, starch, cellulose, alginate, ethylene vinyl alcohol, polyvinyl alcohol, and copolymers containing one or more thereof.

3. The method according to claim 1, wherein the radical initiator is a peroxide initiator or a benzoate based radical initiators.

4-7. (canceled)

8. The method according to claim 1, wherein the first reaction conditions comprise a temperature below a melting temperature of the radical scavenging ligand and above a melting temperature of the polymeric material.

9. The method according to claim 8, wherein the first reaction conditions are carried out using a mixture comprising the polymeric material, the radical scavenging ligand, and the radical initiator.

10. (canceled)

11. The method according to claim 8, wherein the first reaction conditions are carried using a first mixture comprising the polymeric material and the radical initiator, but not the radical scavenging ligand.

12. The method according to claim 11 further comprising, before said reacting:
mixing the polymeric material with the radical initiator to form the first mixture; and
introducing the first mixture into the extruder.

13. (canceled)

14. The method according to claim 11 further comprising introducing the radical scavenging ligand into the extruder at a location between where the first reaction conditions are met and the second reaction conditions are met to form a second mixture comprising the polymeric material, radicals of the polymeric material, the radical initiator, and the radical scavenging ligand.

15. The method according to claim 9, wherein the second reaction conditions comprise a temperature above the melting temperatures of both the radical scavenging ligand and the polymeric material.

16. (canceled)

17. The method according to claim 14 wherein reaction of the radical of the polymeric material with the radical of the radical scavenging ligand forms the direct bond while maintaining the radical scavenging capacity of the covalently bound radical scavenging ligand.

18-24. (canceled)

25. The method according to claim 1, wherein the active and/or intelligent packaging material is an active and/or intelligent food-grade packaging material.

26. A method of forming a food packaging material, the method comprising:
melting the active and/or intelligent packaging material prepared according to claim 25;
forming the melted active and/or intelligent packaging material into a shaped, food packaging material.

27-31. (canceled)

32. An active and/or intelligent packaging material prepared according to the method of claim 1.

33. A food packaging material prepared according to the method of claim 26.

34. An active and/or intelligent packaging material comprising a polymeric material having covalently attached thereto a radical scavenging ligand.

35. The active and/or intelligent packaging material according to claim 34, wherein the radical scavenging ligand is a phenolic or polyphenolic ligand or a hydroxylamine ligand.

36. The active and/or intelligent packaging material according to claim 35, wherein the direct bond is formed between (i) a ring carbon of the phenolic or polyphenolic ligand and either the tertiary carbon or the hydroxyl oxygen of the polymeric material; or (ii) the hydroxyl oxygen of the hydroxylamine ligand and the tertiary carbon of the polymeric material.

37. The active and/or intelligent packaging material according to claim 34, wherein the radical scavenging ligand is curcumin, curcumin derivatives, ferulic acid, quercetin, catechol, catechin, resveratrol, stillbenoids, and combinations thereof.

38. The active and/or intelligent packaging material according to claim 34, wherein the polymeric material is selected from the group consisting of polylactic acid, polypropylene, polybutylene, polyhydroxy butyrate, starch, cellulose, alginate, ethylene vinyl alcohol, polyvinyl alcohol, and copolymers containing one or more thereof.

39. The active and/or intelligent packaging material according to claim 34, wherein the polymeric material is polypropylene or polylactic acid.

40. The active and/or intelligent packaging material according to claim 39, wherein the radical scavenging ligand is curcumin.

41. The active and/or intelligent packaging material according to claim 34, wherein the active packaging material comprises about 0.1 to about 5 wt % of the radical scavenging ligand.

42. The active and/or intelligent packaging material according to claim 34, in the form of pellets.

43. The active and/or intelligent packaging material according to claim 34, in the form of a bag, a single or multi-layer film, or a molded container.

44. The active and/or intelligent packaging material according to claim 34, wherein the active and/or intelligent packaging material comprises a body having a food contact surface and an external surface, wherein the radical scavenging ligand is present on both the food contact surface and on the external surface.

45. A method of packaging perishable food comprising:
sealing a perishable food item in a package comprising an active and/or intelligent packaging material according to claim 34, whereby the food item contacts a surface of the active and/or intelligent packaging material and the radical scavenging ligand thereon.

46-50. (canceled)
